(19) United States
(12) Patent Application Publication
(10) Pub. No.: US 2025/0036962 A1
(43) Pub. Date: Jan. 30, 2025

(54) MODEL AUGMENTATION FRAMEWORK FOR DOMAIN ASSISTED CONTINUAL LEARNING IN DEEP LEARNING

(71) Applicant: Oracle International Corporation, Redwood Shores, CA (US)

(72) Inventors: Edwin Thomas, Bengaluru (IN); Amit Agarwal, Kolkata (IN); Sandeep Jana, Bengaluru (IN); Kulbhushan Pachauri, Bengaluru (IN)

(73) Assignee: Oracle International Corporation, Redwood Shores, CA (US)

(21) Appl. No.: 18/406,905

(22) Filed: Jan. 8, 2024

Related U.S. Application Data
(60) Provisional application No. 63/529,297, filed on Jul. 27, 2023.

(51) Int. Cl. G06N 3/098

(52) U.S. Cl. CPC G06N 3/098

(57) ABSTRACT

Techniques are described herein for generating block extender model. An example method includes a system accessing a base model trained for identifying a base class. The system can access an extender comprising block extenders, the extender class distinct from the base class. The system can connect the extender with the base model to generate an augmented model. The system can input training data to the augmented model, the training data is provided to the base model and the extender, the training data comprising data points associated with the extender class. The system can train the extender model to identify the extender class based at least in part on the training data and the signal received from the base machine learning model. The system can generate a trained extender based at least in part on the training, the extender trained to identify an object associated with the extender class.

### CROSS-REFERENCE TO RELATED APPLICATIONS

This application claims the benefit of U.S. Provisional Application No. 63/529,297, filed on Jul. 27, 2023, the disclosure of which is incorporated by reference herein in its entirety for all purposes.

### BACKGROUND

A cloud service provider (CSP) can provide multiple cloud services to subscribing customers. These services are provided under different models, including a Software-as-a-Service (SaaS) model, a Platform-as-a-Service (PaaS) model, an Infrastructure-as-a-Service (IaaS) model, and others.

An example service that can be provided by the CSP is a machine learning (ML)-based service. The CSP can train a machine learning model using various techniques to support a customer's request. Transfer learning on large pretrained models is an example of one technique for training a machine learning model to learn a new task in the ML context. One issue is the resulting model can generally lose its ability to perform equally on the existing classes (pretrained classes), a phenomenon commonly referred to as catastrophic forgetting. Enabling a model to support pretrained and newly seen classes without deterioration in its performance on previously encountered tasks is a field of research known as continual learning (CL).

### BRIEF SUMMARY

Embodiments herein describe techniques for using a unified framework for connecting a base model to an extender model to generate an augmented model that can perform a customized task. The unified framework can include inter type and intra type extenders that can extract/isolate important information from the base model in regard to a given dataset and domain. The extenders can be connected a base model to facilitate predictions on related domains without requiring previous task data upon which the base model was trained. For inter type extenders, the extenders can enable the base model to retain its previous learning and hence do not cause any performance drop on pretrained classes which is a standard bottleneck for CL methods. An augmented model that includes an inter type extender can include the base model that can continue to perform the original task for which it was trained. The augmented model with the intra type extender can further include an intra type extender that can be trained to perform a task that is distinct from the task that the base model performs. An augmented model with an intra type extender can be trained to use previous learning and perform a new task.

The unified framework can further include fusion layers that learn to effectively combine knowledge from previously learned tasks to facilitate faster knowledge transfer or the adaptation to new datasets.

The inter type and the intra type extenders can encode information from previous training datasets. Hence, the preceding task datasets do not need to be explicitly stored for CL training jobs. The learning blocks and fusion layers can enable adding learnable blocks to any ML model architecture (single or multi-modal) and can be further fine-tuned for optimization and performance.

The unified framework can support the indexing of inter type and intra type extenders in a data store based on domain metadata. Hence, inter type and intra type extenders from related domains can be fetched on-demand from the data store and fused during training to facilitate faster knowledge transfer on associated customer tasks in a plug-and-play fashion. The unified framework can enable faster learning for the new tasks and domain data while retaining the performance of the previously trained base classes or custom classes.

Additionally, a data store can store a mapping from a domain to dataset-specific extenders from past iterations to provide more fine-grained control over the extenders to be used for a new customer task. Due to the portable nature of learnable blocks, the unified framework CL can use a single training stage based on on-demand selection and fusion of machine learning blocks.

Embodiments herein are directed toward techniques for training an inter type augmented model, wherein a technique can include, for example, a method, a computing system, or one or more computer readable media. An example method can include a computing system identifying a custom class.

The method can further include the computing system selecting a pretrained base model trained to predict a base class. The selection can be based at least in part on the base class belonging to the same domain as the custom class.

The method further includes the computing system generating an untrained inter type extender model to be trained to predict the custom class from data points associated with the custom class. The untrained inter type extender model can include an untrained fusion layer and an untrained inter type extender.

The method can further include the computing system connecting the pretrained base model in parallel to the untrained inter type extender model to generate an inter type augmented model.

The method can further include the computing system inputting a training image into the inter type augmented model. The training image can include the data points associated with the custom class.

The method can further include the computing system causing, based at least in part on the training image, a first block of the pretrained base model to output a first plurality of activations associated with the base class.

The method can further include the computing system causing the untrained fusion layer to generate a plurality of weights for weighting the first plurality of activations. The plurality of weights can be configured to cause the untrained inter type extender model to identify the custom class from the training image.

The method can further include the computing system causing the untrained fusion layer to generate a weighted sum based at least in part on weighting the first plurality of activations using the plurality of weights.

The method can further include the computing system causing the pretrained base model to predict the base class from the training image based at least in part on the first plurality of activations.

Embodiments can further include techniques for training an intra type augmented model, wherein a technique can include, for example, a method, a computing system, or one or more computer readable media. An example computing system can include one or more processors and one or more computer-readable media including instructions that, when executed by the one or more processors, can cause the one or more processors to identify an identity of a custom class.

The instructions that, when executed by the one or more processors, can cause the one or more processors to select a pretrained base model trained to predict a base class, the selection based at least in part on the base class belonging to a same domain as the custom class.

The instructions that, when executed by the one or more processors, can cause the one or more processors to generate an untrained intra type extender model to be trained to identify the custom class from data points associated with the custom class, the untrained intra type extender model comprising an untrained fusion layer, a first untrained intra type extender layer and a second untrained extender layer.

The instructions that, when executed by the one or more processors, can cause the one or more processors to input training data to connect the untrained intra type extender model to the pretrained base model to generate an intra type augmented model.

The instructions that, when executed by the one or more processors, can cause the one or more processors to input a training image to the intra type augmented model, the training image comprising the data points associated with the custom class.

The instructions that, when executed by the one or more processors, can cause the one or more processors to cause, based at least in part on the training image, a first block of the pretrained base model to output a first plurality of activations.

The instructions that, when executed by the one or more processors, can cause the one or more processors to cause, based at least in part on the training image, the first untrained intra type extender layer to output a second plurality of activations.

The instructions that, when executed by the one or more processors, can cause the one or more processors to cause the untrained fusion layer to generate a plurality of weights for weighting the first plurality of activations and the second plurality of activations, the plurality of weights configured to cause the intra type augmented model to identify the custom class from the training image.

The instructions that, when executed by the one or more processors, can cause the one or more processors to cause a second block of the pretrained base model to output a third plurality of activations based at least in part on the weighted sum.

The instructions that, when executed by the one or more processors, can cause the one or more processors to cause the second untrained extender layer to output a fourth plurality of activations based at least in part on the weighted sum.

The instructions that, when executed by the one or more processors, can cause the one or more processors to cause the intra type augmented model to predict the custom class from the training image based at least in part on the third plurality of activations and the fourth plurality of activations.

Embodiments here are directed toward techniques for maintaining a data store, wherein a technique can include, for example, a method, a computing system, or one or more computer readable media. An example method can include a data store receiving a message requesting a model that is trained to predict a custom class.

The method can further the data store selecting a pretrained base model from a plurality of pretrained base models that is trained to predict a base class belonging to a same domain as the custom class.

The method can further the data store selecting a first pretrained extender model from a plurality of pretrained extender models. The first pretrained extender model can be associated with the pretrained base model based at least in part on selecting the pretrained base model. The first pretrained extender model can be trained to predict the custom class.

The method can further the data store connecting the pretrained base model to the first pretrained extender model to generate an augmented model based at least in part on the first pretrained extender model being trained to predict the custom class. The pretrained base model can be connected to the first pretrained extender model such that a first output of a first block of the pretrained base model is received by a first pretrained fusion layer of the pretrained extender model.

The method can further the data store transmitting the augmented model to a sender of the message.

### BRIEF DESCRIPTION OF THE DRAWINGS

FIG. 1A is an example process flow for generating an extender model, according to one or more embodiments.

FIG. 1B is an example process flow for generating an inter block-extender model, according to one or more embodiments.

FIG. 1C is an example process flow for generating an intra type-extender model, according to one or more embodiments.

FIG. 2 is an illustration of an example system for generating an augmented model, according to one or more embodiments.

FIG. 3 is an illustration of an example augmented model training system for generating a target augmented model, according to one or more embodiments.

FIG. 4 is an illustration of an example inter type augmented model target, according to one or more embodiments.

FIG. 5 is an illustration of an example fusion layer, according to one or more embodiments.

FIG. 6 is an example augmented model with one or more intra type extender models, according to one or more embodiments.

FIG. 7 is an illustration of an example intra type extender unit, according to one or more embodiments.

FIG. 8 is an illustration of an example intra type extender unit, according to one or more embodiments.

FIG. 9 is an illustration of an example intra type extender unit, according to one or more embodiments.

FIG. 10 is an example process flow for using an augmented model with one or more intra type extender models, according to one or more embodiments.

FIG. 11 is an example process flow for training an inter type extender model, according to one or more embodiments.

FIG. 12 is an example process flow for training an intra type extender model, according to one or more embodiments.

FIG. 13 is an example process flow for maintaining a data store, according to one or more embodiments.

FIG. 14 is a block diagram illustrating one pattern for implementing a cloud infrastructure as a service system, according to at least one embodiment.

FIG. 15 is a block diagram illustrating another pattern for implementing a cloud infrastructure as a service system, according to at least one embodiment.

FIG. 16 is a block diagram illustrating another pattern for implementing a cloud infrastructure as a service system, according to at least one embodiment.

FIG. 17 is a block diagram illustrating another pattern for implementing a cloud infrastructure as a service system, according to at least one embodiment.

FIG. 18 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

With respect to a cloud services provider (CSP), the necessity for class extension can arise when a customer wants to leverage the capabilities of the pretrained models while extending the pretrained models to a few novel classes. Once the model has been fine-tuned on a customer task, it may have undergone a significant alteration in its weights, which confines its re-usability on subsequent related downstream tasks. This imposes the constraint of one specific set of model parameters per dataset. This can be suboptimal in terms of cost, time, and effort for potential customer use cases centered around seasonally changing datasets where slight variances in their domain data occur periodically. Satisfying a customer's request for a task, may require fine-tuning a large pretrained model from scratch. Existing CL techniques that aim to address some of these issues suffer from several drawbacks that make them less favorable for commercial use cases. For example, existing CL methodologies generally require a subset of the training data on previous tasks to be stored for memory replays (e.g., showing the previous datasets again to the model). This imposes security concerns about storing and accessing confidential customer data stored in their respective tenancies. Additionally, existing CL methodologies require longer inference times associated with the higher model complexity, or longer training durations due to multiple optimization stages that are used to trim the resultant model to get a better-optimized model with a slight drop in performance (often referred to as “quantization”). Furthermore, existing CL methodologies are associated with a lack of fine-grained control over domain-specific learnable model parameters related to the specified task.

Embodiments herein address the above-referenced issues by introducing techniques for using a unified framework for connecting a base model to an extender model to generate an augmented model. The unified framework can be based on the efficient single-stage training of CL models. The unified framework includes inter type and intra type extenders that can extract/isolate important information about a given dataset and domain. The extenders can be attached/plugged into a base model to facilitate predictions on related domains without requiring previous task data. For inter type extenders, the extenders can enable the base model to retain its previous learning and hence do not cause any performance drop on pretrained classes which is a standard bottleneck for CL methods.

The unified framework can further include fusion layers that learn to effectively combine knowledge from previously learned tasks to facilitate faster knowledge transfer or the adaptation to new datasets.

The extenders can encode information from previous training datasets. Hence, the preceding task datasets do not need to be explicitly stored for CL training jobs. The learning blocks and fusion layers can enable adding learnable blocks to any ML model architecture (single or multi-modal) and can be further fine-tuned for optimization and performance.

The unified framework supports the indexing of extenders in a data store based on domain metadata. Hence, extenders from related domains can be fetched on-demand from the data store and fused during training to facilitate faster knowledge transfer on associated customer tasks in a plug-and-play fashion. The unified framework enables faster learning for the new tasks and domain data while retaining the performance of the previously trained base classes or custom classes.

Additionally, a data store can store a mapping from a domain to dataset-specific extenders from past iterations to provide more fine-grained control over the extenders to be used for a new customer task. Due to the portable nature of learnable blocks, the unified framework CL can use a single training stage based on on-demand selection and fusion of machine learning blocks.

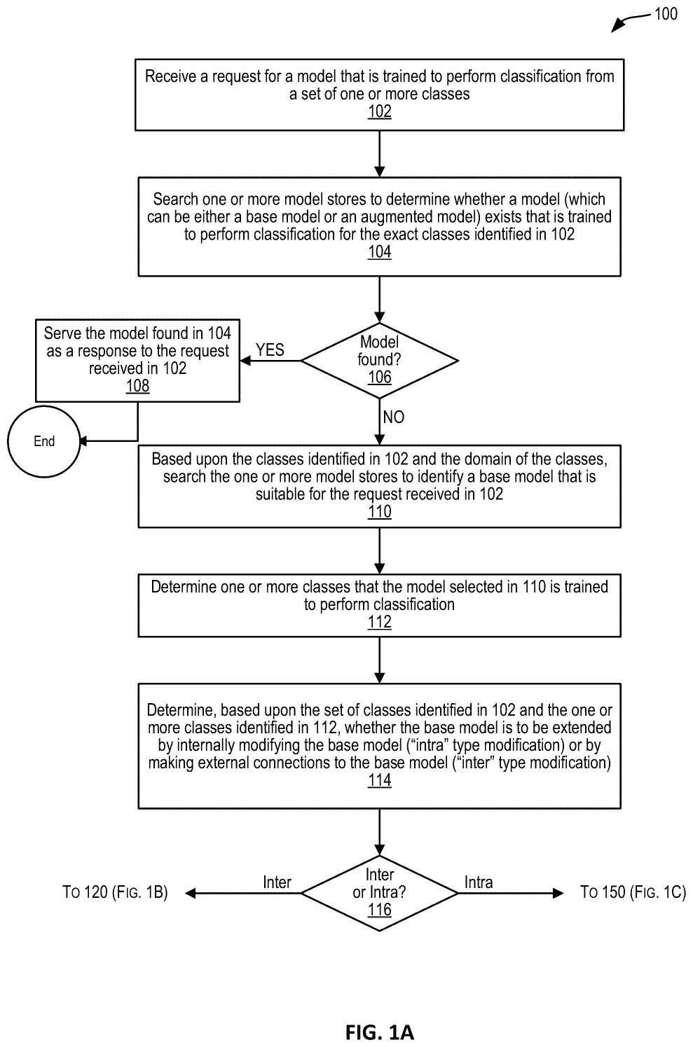

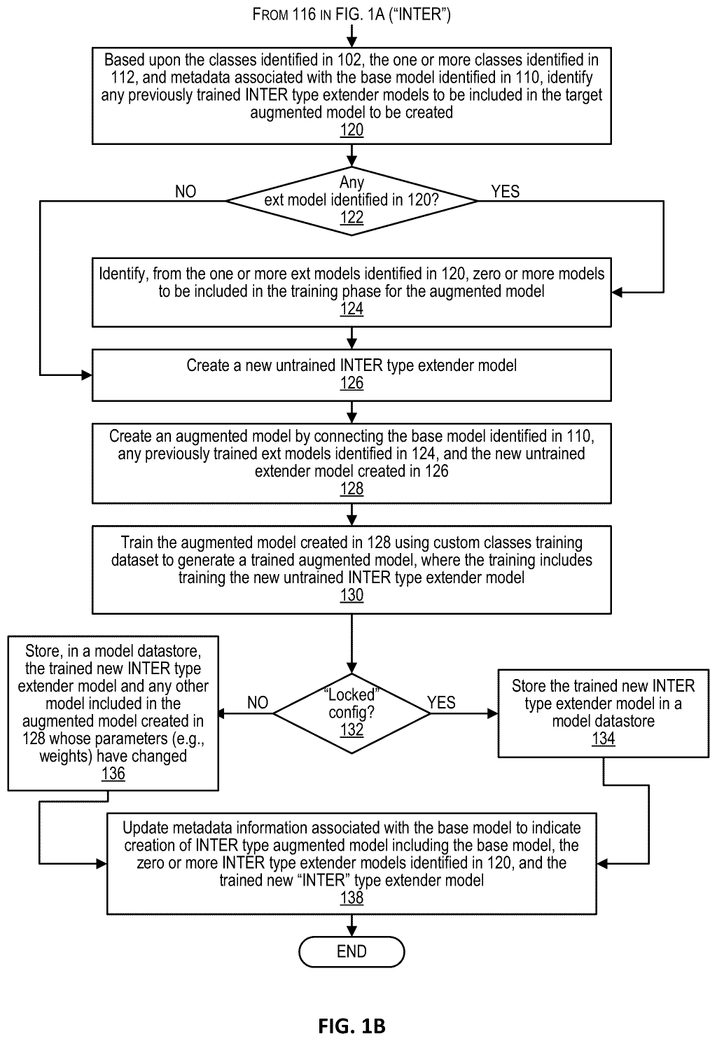

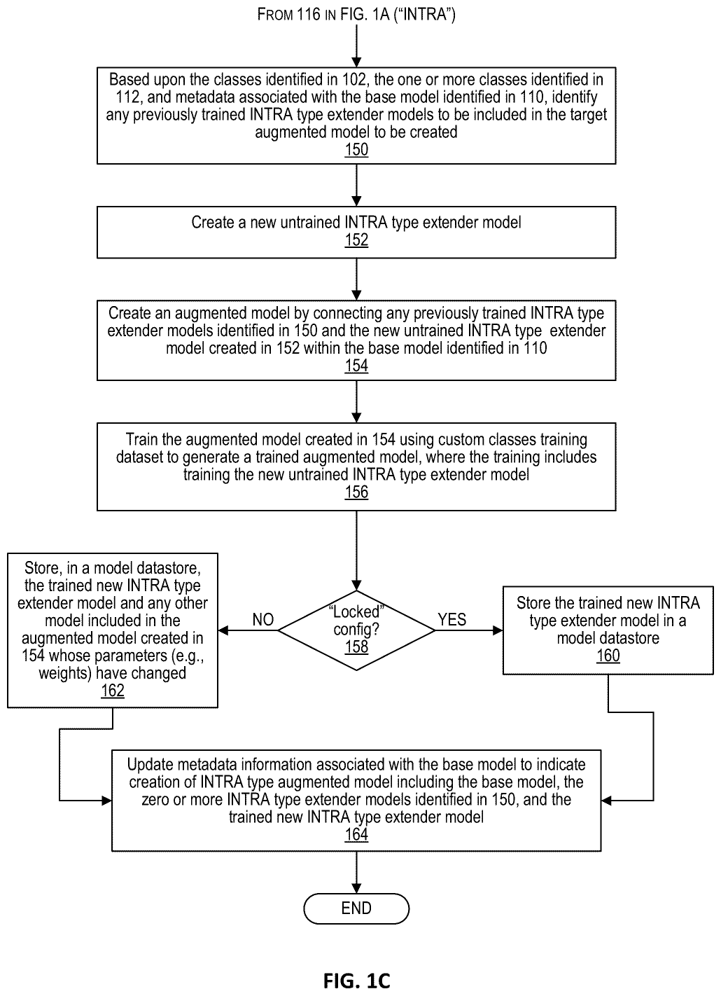

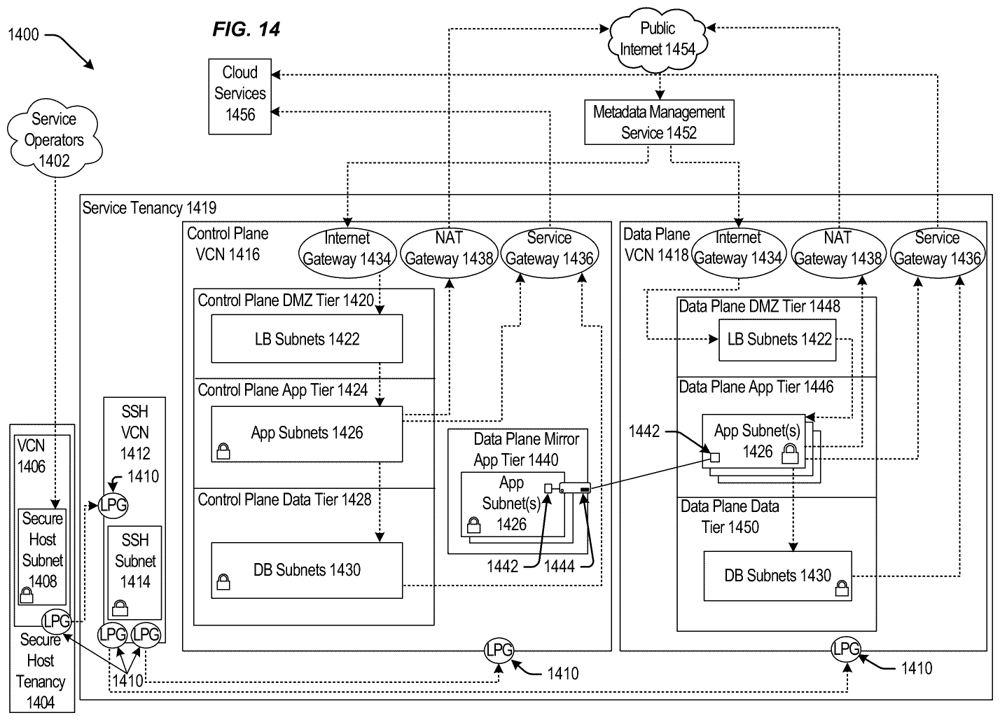

FIG. 1 is an example process flow for generating an extender model, according to one or more embodiments. At 102, a computing system, such as an augmented model training system, can receive a request for a model that is trained to perform classification from a set of one or more classes. The computing systems described herein can be implemented by various computing systems, such as the systems described in FIGS. 14-18. For example, a customer of a CSP may request a model that can classify a custom class, such as breeds of cats and breeds of dogs.

At 104, the computing system can search one or more model data stores to determine whether a model that is trained to perform classification for the exact classes identified in 102 exists. The one or more model data stores can include various models, such as previously trained base models, and previously trained extender models. In some instances, the model can include an augmented model that includes a base model connected to a trained extender model.

At 106, the computing system can determine whether a model that is trained to perform classification for the exact classes identified in 102 is found. If a model is found in 104, then at 108, the model is served as a response to the request received in 102 and the process ends.

If, however, the model is not found at 104, based on the classes identified in 102 and the domain of the classes, at 110 the computing system can search the one or more models that may be suitable for the request received in 102. The objective for the computing system can be to identify a model that is trained to classify a class or classes that is the closest to the one or more classes requested in 102. Consider an example, in which the computing system uses a domain of “animals” to narrow its search. The search result may yield multiple different models. The computing system can then further narrow its search by identifying which, if any, of the multiple different models is closest to be trained to classify the one or more classes identified in 102 (e.g., breeds of cats and breeds of dogs). If the search yields a first base model that classifies cats, a second model that classifies dogs, a third model that classifies cats and dogs, and a fourth model that classifies cats and horses, the closest model is the third model that classifies cats and dogs, and therefore the computing system can select the third model at 110.

At 112, the computing system can determine one or more classes that the model selected in 110 is trained to perform classification. At 114, the computing system can determine, based on the set of classes identified in 112, whether the base model is to be extended by internally modifying the base model (e.g., an intra type modification) or by making external connections to the base model (e.g., an inter type modification). For example, if the requested one or more classes from 102 included cats, dogs, and horses and the model selected at 110 is trained to classify cats and dogs, the inter type modification can be selected to add an extender model for classifying horses. If, however, one or more requested classes from 102 is breeds of cats and the model selected at 110 is trained to classify cats, the intra type modification can be selected to modify the model to classify breeds of cats. At 116, the process flow can proceed 120 or 150 based on whether an inter type modification is selected or an intra type modification is selected.

FIG. 1B is an example process flow for generating an inter type extender model, according to one or more embodiments. At 120, based on the classes identified in 102, the one or more base classes identified in 112, and metadata associated with the base model identified in 110, the computing system can identify any previously trained inter type extender models to be included in the target augmented model. The metadata can include information associated with a base model, and identify each augmented model that the base model is a part of. For example, the base model may be connected to a first inter type extender model, and a duplicate of the base model may be connected to a second inter type extender model. In any case, the metadata can provide information as each of the inter type extender models. For example, if the one or more requested classes identified in 102 included cats, dogs, and horses, and the base model is trained to classify cats, the computing system can use the metadata and the classes identified in 102 to determine whether there is one or more inter type extender models that may be trained to classify either dogs, horses, or both.

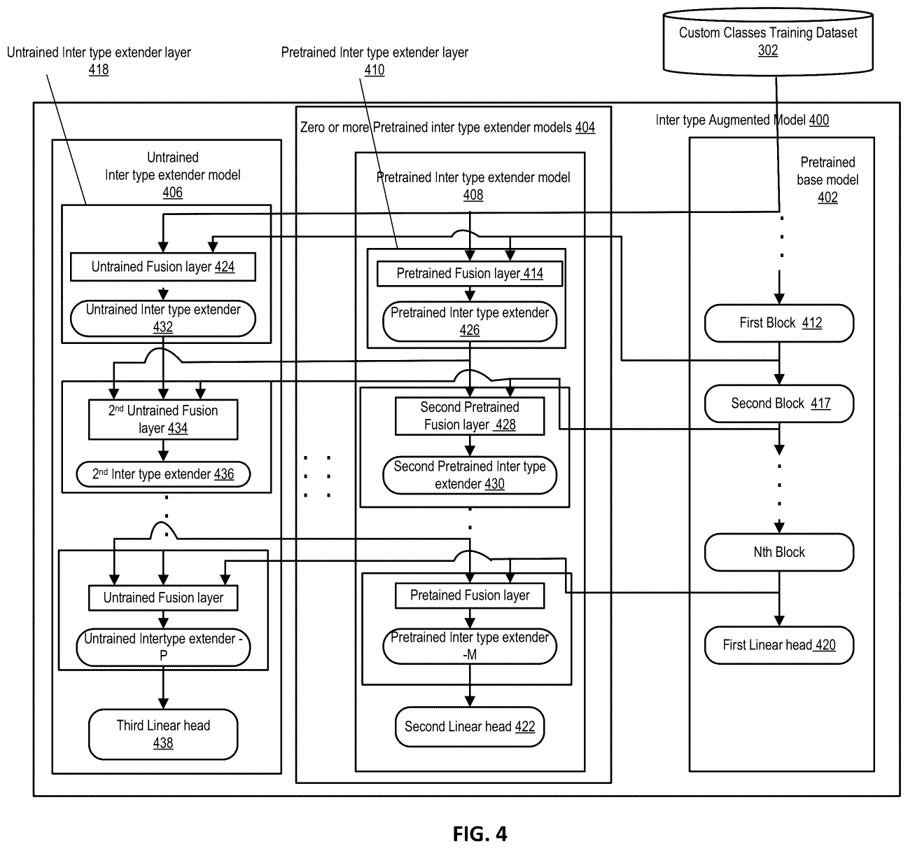

At 122, the computing system can determine whether any previously trained inter type extender models was identified at 120. If a previously trained inter type extender was identified, identify zero or more inter type extender models to be included in the training phase for the augmented model at 124. The decision to include an inter type extender model can be based on various factors, such as a compatibility of the architecture of the inter type extender model and the base model, the one or more classes the inter type extender model is trained for. If, however, no previously trained inter type extender model is identified at 122, the computing system can create an inter type extender model at 126. A description of the inter type extender model is described with more particularity with respect to FIG. 4.

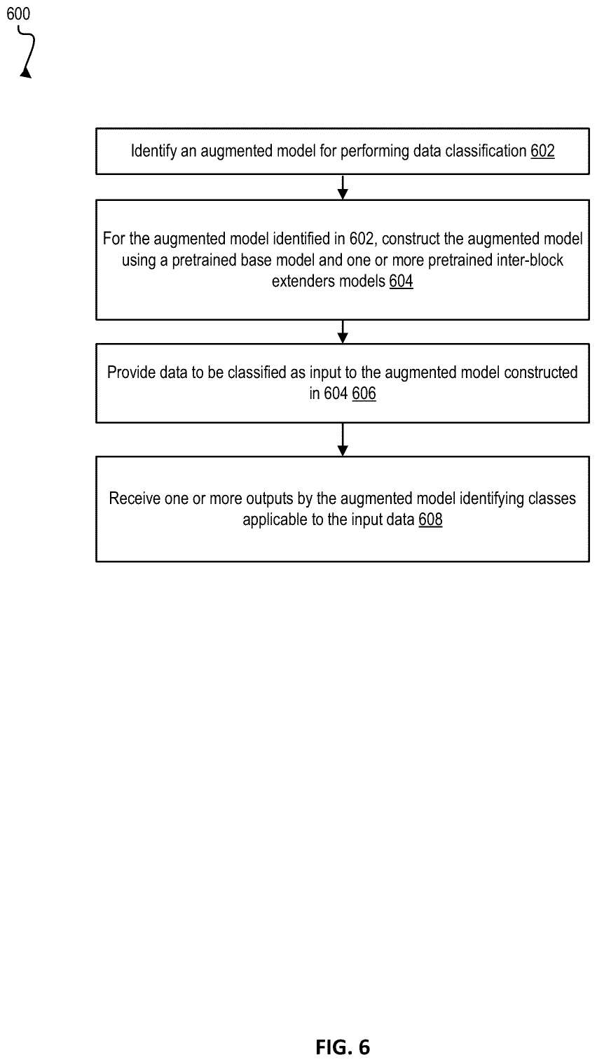

At 128, the computing system can create an augmented model be connecting the base model identified at 110, any previously trained inter type extender models, and the any new untrained inter type extender model created at 126. The inter type extender model can be connected in parallel with the base model. In particular, the inter type extender model can include a sequence of inter type extender layers, in which each inter type extender layer includes a fusion layer and an inter type extender. Each inter type extender layer can be connected to a corresponding base block of the base model. An augmented model that includes an inter type extender model connected to a base model is described with more particularity with respect to FIG. 6.

At 130, the computing system can train the augmented model created in 128 using a custom classes training dataset to generate a trained augmented model. The training can include training the new untrained inter type extender model. The training can include a locked configuration training or an unlocked training configuration. The locked configuration training can include locking the parameters (e.g., weights) of the base model. In this configuration a cost function is used to determine the accuracy of the inter type extender model. Furthermore, the parameters of the inter type extender model can be adjusted using backpropagation. The parameters of the base model are locked and not adjusted. The unlocked training configuration can include using a cost function access the accuracy of any inter type extender model and the accuracy of the base model. The parameters of any inter type extender model and base model can be adjusted using backpropagation. At 132, the computing system can determine whether a locked configuration or an unlocked configuration is to be used. The decision can be based on, for example, user input.

If, at 132, the computing system determines to use the locked configuration, the computing system can store the trained inter type extender model in a model data store at 134. If, however, the computing system determines to use the unlocked configuration, the computing system can store the inter type extender model and any other model included in the augmented model created in 128, as the parameters of the base model and any pretrained inter type extender model may have changed at 136.

At 138, the computing system can update metadata information associated with the base model to indicate the creation of the inter type augmented model, the zero or more inter type extender models identified in 120, and the newly trained inter type extender model.

FIG. 1C is an example process flow for generating an intra type extender model, according to one or more embodiments. Steps 150 through 164 relate to an intra type extender model. At 150, based on the classes identified at 102, the one or more classes identified at 112, and metadata associated with the base model identified at 110, the computing system can identify any previously trained intra type extender models to be included in the augmented model to be created.

At 152, the computing system can create a new untrained intra type extender model. It should be appreciated that for an inter type augmented model, a previously trained inter type extender model connected to the base model can be disconnected and replaced with an untrained inter type extender model. For an intra type extender model, if a base model has been connected to an intra type extender model, and the intra type extender model has been trained with the base model, a new untrained intra type extender model is to be connected to the intra type augmented model that includes both the base model and the previously trained intra type extender model.

At 154, the computing system can create an intra type augmented model by connecting any previously trained intra type extender models identified at 150 and the new untrained intra type extender model created at 152 to the base model identified at 110.

At 156, the computing system can train the intra type augmented model created at 154 using a custom classes training dataset to generate a trained inter type augmented model. The training can include training the new untrained intra type extender model.

If at 158, the computing system used a locked configuration to train the intra type augmented model, the computing system can store the trained intra type extender model in a model data store at 160. If, however, the computing system used an unlocked configuration to train the intra type augmented model, the computing system can store the trained intra type augmented model created at 154, as the parameters of the base model and nay pretrained intra type extender model may have changed at 162.

At 164, the computing system can update the metadata information associated with the base model to indicate the creation of the intra type augmented model, the zero or more intra type extender models identified at 150, and the newly trained intra type extender model.

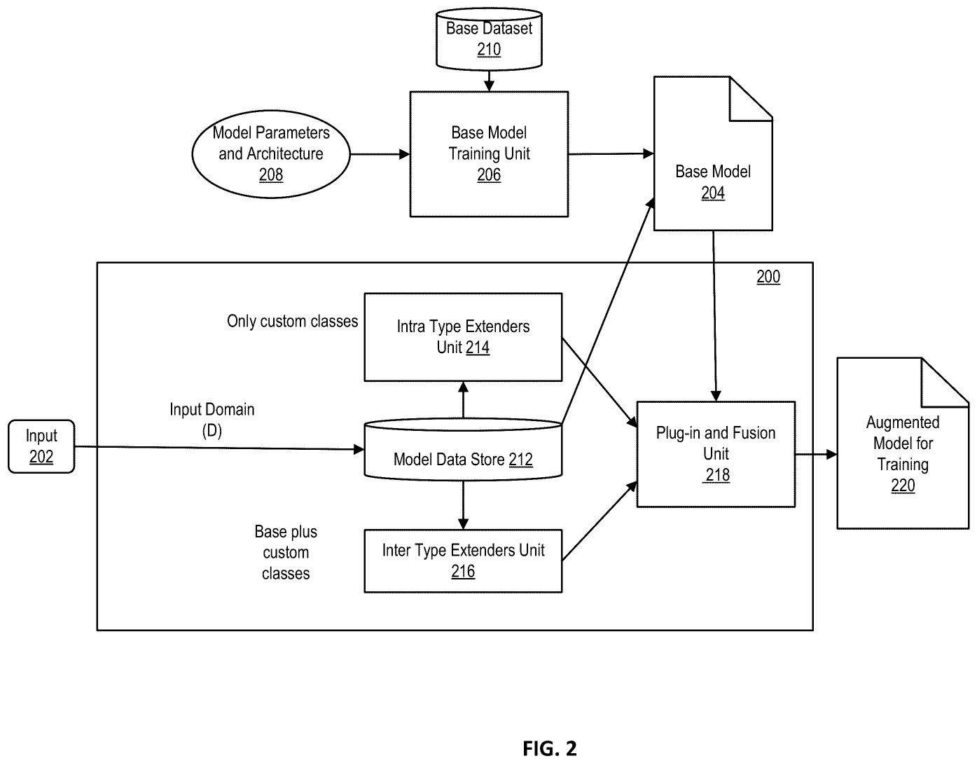

FIG. 2 is an illustration of a computing system 200 for generating an augmented (e.g., inter type or intra type) model, according to one or more embodiments. A CSP can receive a request for a machine learning model that is trained to perform a classification of one or more custom classes. The computing system 200 can receive an input 202 from the CSP, including control instructions to train a base model 204 for requested one or more classes. The base model 204 can be implemented by a neural network, such as a convolutional neural network (CNN) and include a single, binary, or a multiple class classifier. The base model 204 can have been previously trained using a base model training unit 206, which can be a computing system configured to train a machine learning model. The base model training unit 206 can receive model parameters and architecture 208. The model parameters can include various hyperparameters, for example, a number of hidden layers, a learning rate, and regularization strength. The architecture can include a definition of the input layer, the hidden layers, and an output layer. The base model 204 can further be trained using a base dataset 210 that includes various training instances for training the base model 204. For example, in a supervised learning environment, the base dataset 210 can include annotated images of one or more base classes. For example, if the base model 204 is to be trained to classify cats and dogs, the base dataset 210 can include annotated images of cats and dogs.

At a different time, a customer may request a model that classifies breeds of cats. As indicated above, the base model 204 has previously been trained to classify cats and dogs. The herein described techniques permit leveraging the base model's ability to classify cats and dogs to train a model to classify breeds of cats.

As indicated in FIGS. 1B and 1C, the computing system can access a model data store 212 to determine if there are any previously trained models that are trained to classify the custom class (e.g., breeds of cats). If the computing system cannot identify a trained model in the model data store that is trained to identify the custom class, then the computing system can create either an inter type extender or an intra type extender to be trained to classify the custom class. If the control instructions indicate that the model is to be trained to only classify the new class, the computing system 200 can use the intra type extenders unit 214 to create intra type extender model as indicated in 152. If, however, the control instructions indicate that the model is to be trained to classify the new class and also any class for which the base model 204 was trained, the computing system 200 can use the inter type extenders unit 216 to create a inter type extender model as indicated in 126.

In the event that the computing system 200 creates a new intra type extender model, the computing system can use a plug-in and fusion unit 218 to create an augmented model 220 (e.g., intra type) by connecting the base model 204 to the new untrained intra type extender model as described in 154. In the event that the computing system 200 creates a new inter type extender model, the computing system can use the plug-in and fusion unit 218 to create an augmented model 220 by connecting the base model 204 to the untrained inter type extender model as described in 128.

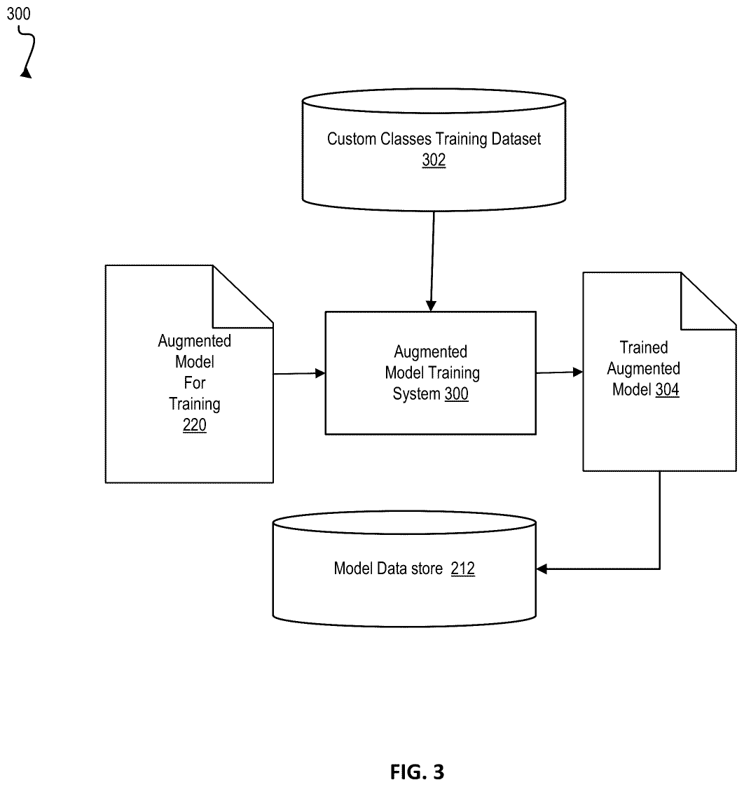

FIG. 3 is an illustration of an augmented model training system 300 for generating a trained augmented model, according to one or more embodiments. The augmented model training system 200 can receive an augmented model for training. The augmented model can either be an inter type augmented model (see, FIG. 1B) or an intra type augmented model (See FIG. 1C). The augmented model training system 300 can further receive a custom classes training dataset 302. The custom classes training dataset 302 can be a training set used to train the augmented model 220 to classify the one or more classes identified in step 102. For example, the custom classes training dataset 302 can images with data points of objects, such as animals, or images of other objects.

The custom classes training dataset 302 can be based on which classes that the augmented model 220 is to be trained to classify as indicated in 102. This can further be dependent upon whether the augmented model is an inter type augmented model or an intra type augmented model. For example, for an inter type augmented model, there are at least two variations, where a first variation can include base model connected to an untrained inter type extender model, and a second variation can include a base model connected to one or more previously trained inter type extender model(s) and an untrained inter type extender model. The one or more classes identified in 102 may include cats, dogs, and breeds of cats. Using the first variation, in a first instance, the base model may be trained to only classify cats. In this case, the untrained inter type extender model may need to be trained to classify dogs and breeds of cats. Therefore, the custom classes training dataset 302 can include annotated images of dogs and breeds of cats. In a second instance of the first variation, the base model may be trained to classify cats and dogs. In this case, the untrained inter type extender model may need to be trained to classify breeds of cats. Therefore, the custom classes training dataset 302 can include annotated images of breeds of cats. Similar examples can be contemplated for the second variation. The augmented model training system 300 can train the inter type augmented model as described in step 130 using the custom classes training dataset 302 to generate the trained augmented model 304 (in this example a inter type augmented model).

For an intra type augmented model there can also at least two variations, where a first variation can include base model connected to an untrained intra type extender model, and a second variation can include a base model connected to one or more previously trained intra type extender model(s) and an untrained intra type extender model. Using the first variation, in a first instance, the base model may be trained to classify cats and dogs and the one or more classes identified in 102 can be breeds of cats and breeds of dogs. In this case, the custom classes training dataset 302 can include annotated images of breeds of cats and breeds of dogs. In a second instance of the first variation, the base model may be trained to classify cats, dogs, and the one or more classes identified in 102 can be breeds of cats and breeds of dogs. In this case, the custom classes training dataset 302 can include annotated images of dogs, breeds of cats, and breeds of dogs. Similar examples can be contemplated for the second variation. The augmented model training system 300 can train the intra type augmented model as described in step 156 using the custom classes training dataset 302 to generate the trained augmented model 304 (in this example, an intra type augmented model).

As indicated in steps 132 and 158, the training can include a locked configuration or an unlocked configuration. For a locked configuration and an inter type augmented model, the augmented model training system 300 can store the trained new inter type extender model in the model data store 306, as described in step 134. For an unlocked configuration, the augmented model training system 300 can store the trained new inter type augmented model in the model data store 306, as described in step 136.

For a locked configuration and an intra type augmented model, the augmented model training system 300 can store the trained new intra type extender model in the model data store 306, as described in step 160. For an unlocked configuration, the augmented model training system 300 can store the trained new intra type augmented model in the model data store 306, as described in step 162.

### Inter Type Extender Model

FIG. 4 is an illustration of an inter type augmented model 400, according to one or more embodiments. As illustrated, the inter type augmented model 400 can include a pretrained base model 402, zero or more pretrained inter type extender models 404, and an untrained inter type extender model 406. It should be appreciated and as described above, in another embodiment the inter type augmented model 400 can include the pretrained base model 402 and the untrained inter type extender model 406. In this instance, the inter type augmented model 400 would not include the zero or more inter type extender models 404.

A pretrained inter type extender layer 410 of the pretrained inter type extender model 408 can be connected to an output of a corresponding first block 412 of the pretrained base model 402. In particular, output of the first block 412 can be received by a pretrained fusion layer 414 of the pretrained inter type extender layer 410. The first block 412, and each subsequent block of the pretrained base model 402 can include a set of convolutional layers that collectively perform one or more tasks (e.g., object detection, features, contour detection, color detection). The outputs of each convolutional layer can be dictated by a set of weights of the block. The second block 417 can also include a set of layers that collectively perform one or more tasks. The first block 412 can be selected to correspond to the pretrained inter type extender layer 410 based on various criteria such as function, trained classes or other appropriate criteria.

It should be appreciated that the first block 412 may not be the initial block of the pretrained base model 402. For example, the pretrained base model 402 can process the custom classes training dataset 302 through various initial blocks until the processing reaches an intermediate block, described in FIG. 4 as a first block 412. For brevity purposes, the initial blocks are not illustrated.

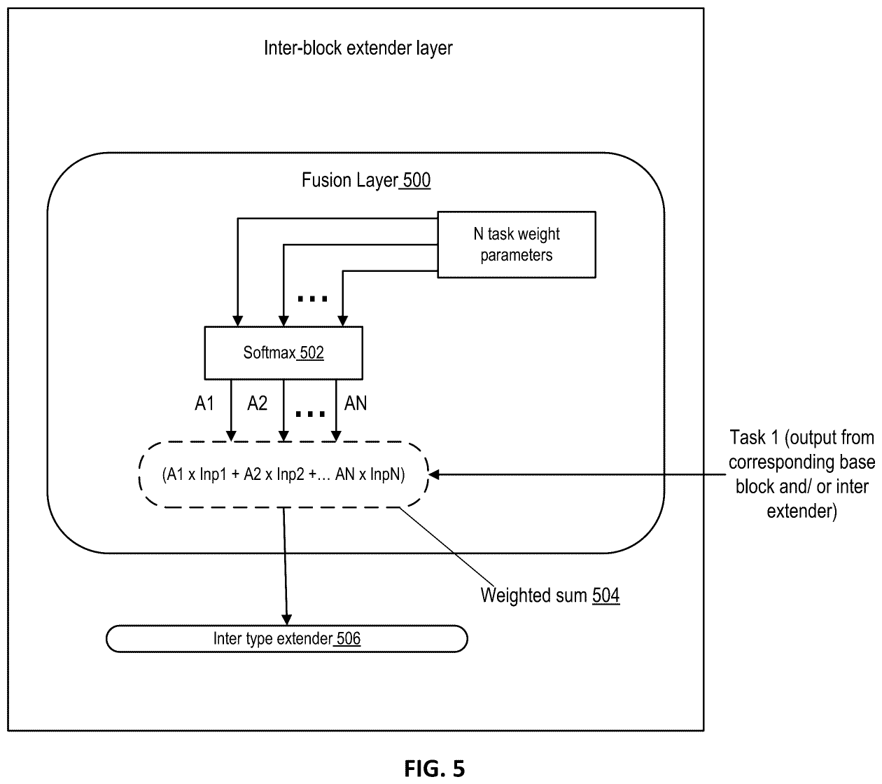

In addition, an untrained inter type extender layer 418 of the untrained inter type extender model 406 can also be connected to and receive the output from the corresponding first block 412 of the pretrained base model 402. In particular, an untrained fusion layer 424 of the untrained inter type extender layer 418 can receive, via an input interface (e.g., an input layer), the custom classes training dataset 302 and the output of the first block 412. A description of the untrained fusion layer 424 is provided with more particularity with respect to FIG. 5.

The untrained inter type extender model 406 can be trained by the augmented model training system 300. Furthermore, the untrained inter type extender model 406 can be the untrained inter type extender model created in step 126. The untrained inter type extender model 406 can be connected to the pretrained base model 402 (e.g., base model identified in step 110) as indicated in step 128. The inter type augmented model 400 can be trained, using the herein described method, such that the model can perform one or more classifications (e.g., breeds of cats) that are different than the classifications of the pretrained base model 402 (e.g., cats). The zero or more pretrained inter type extender models 404 can be connected to the pretrained base model 402 to make one or more classifications (e.g., dogs) that are also different than the one or more classifications (e.g., cats) of the pretrained base model 402. Therefore, in the event that a customer wants to extend the inter type augmented model for a new classification (e.g., breeds of cats), the untrained inter type extender model 406 can be connected to the pretrained base model 402 and the zero or more pretrained inter type extender models 404, if any. The untrained inter type extender model can then be trained as indicated in step 130 to classify breeds of cats.

The inter type augmented model 400 can receive custom classes training dataset 302. For example, the custom classes training dataset 302 can be images (e.g., annotated breeds of cat images), where the pretrained base model 402 is trained to classify cats and the pretrained inter type extender model 408 is trained to classify dogs. In this scenario the zero or more pretrained inter type extender models 404 only includes the pretrained inter type extender model 408. In other scenarios, the zero or more pretrained inter type extender models 404 may include no pretrained inter type extender model or more than one pretrained inter type extender model. The custom classes training dataset 302 can be received by the pretrained base model 402, which can process the custom classes training dataset 302 in accordance with its training. For example, if the pretrained base model 402 is trained to classify cats, the pretrained base model 402 can identify cats from an image in the custom classes training dataset 302. The output of the first block 412 can be a set of activations that can be used by subsequent blocks (e.g., the second block 417) to classify a cat from the image. The first linear head 420 can output a prediction as to whether an image from the custom classes training dataset 302 includes a cat.

The first block 412 can also transmit its output to the trained fusion layer 414. For example, the first block 412 can generate an input sequence represented by a set of activations that describe a portion of a training image. The pretrained fusion layer 414 can use an attention mechanism to generate attention scores using the input sequence. For example, the attention mechanism can be used to generate query vectors and key vectors from the input sequence. The attention mechanism can then take the dot product of corresponding key vectors and query vectors. The dot product can be a measure of the similarity between the key vectors and query vectors. The pretrained fusion layer 414 can then use a function (e.g., SoftMax function) to generate probability distribution to indicate the relative importance of each input of the input sequence as to the desired class based on the dot product. For example, the pretrained inter type extender model 408 can be trained to classify dogs. Therefore, the probability distribution can indicate the relative importance of each input in the input sequence as to classifying dogs. Therefore, even though the first block 412 of pretrained base model 402 is generating activations to assist in classifying a cat, the weighted activation mechanism permits the pretrained inter type extender model 408 to focus on dogs. The probability distribution can be used to generate a weighted sum. The weighted sum can be passed to the pretrained inter type extender 426. The pretrained inter type extender 426 can pass the image through a set of convolutional layers and use the weighted sum as a guide to identify features associated with dogs.

The untrained inter type extender model 406 can also receive the custom classes training dataset 302 and the output (e.g., input sequence) of the first block 412. The untrained fusion layer 424 can be trained to use an attention mechanism to generate attention scores using the input sequence. The attention mechanism can be used to generate query vectors and key vectors from the input sequence. The attention mechanism can then take the dot product of corresponding key vectors and query vectors. The untrained fusion layer 424 can be trained to use a function (e.g., SoftMax function) to generate probability distribution to indicate the relative importance of each input of the input sequence as to the desired class based on the dot product. It should be appreciated that the untrained inter type extender model 406 is to be trained to predict the custom class (e.g., breeds of cats). Therefore, the probability distribution can indicate the relative importance of each input in the input sequence as to the custom class. The probability distribution can be used to generate a weighted sum. The weighted sum can be passed to the untrained inter type extender 432. The untrained inter type extender 432 can be trained to pass the image through a set of convolutional layers and use the weighted sum as a guide to identify features associated with the custom class.

The output of the untrained inter type extender 432 can be transmitted to a second untrained fusion layer 434. The second untrained fusion layer 434 can also receive the output of the second block 417 and the output of the pretrained inter type extender 426 (if the zero or more pretrained inter type extender models 404 includes the pretrained inter type extender model 408). The second untrained fusion layer 434 can be trained to use the outputs of the untrained inter type extender 432, the pretrained inter type extender 426, and the second block 417 to similarly generate a weighted sum. The second inter type extender 436 can transmit the weighted sum to the second inter type extender 436. This process can repeat until the untrained inter type extender model 406 outputs a classification using a third linear head 438. For example, the third linear head 438 can output a prediction as to a breed of cat in an image of the custom classes training dataset 302.

As used herein, each block (e.g., first block 412 and any subsequent blocks) and extenders (e.g., pretrained inter type extender 426 and any subsequent extenders of the pretrained inter type extender model 408, and the untrained inter type extender 432 and any subsequent extenders of the untrained inter type extender model 406) can include one or more layers (e.g., convolutional layers) that implement a forward method to transform inputs into outputs. Each must also be capable of implemented a backward method to calculate a gradient that can be used to determine the accuracy of the block.

The number of blocks in the pretrained base model 402 is not necessarily the same as the number of number of inter type extenders in the pretrained inter type extender model 408 or the untrained inter type extender model 406. In many instances, the initial blocks of the pretrained model perform basic tasks, and the output of these tasks is not transmitted to any fusion layer associated with the pretrained inter type extender model 408 or the untrained inter type extender model 406. Rather the intermediate blocks of the pretrained base model 402 perform more complex tasks that can be used as the basis for training the pretrained inter type extender model 408 or the untrained inter type extender model 406. Therefore, in some instances the number of blocks of the pretrained model is greater than the number of number of inter type extenders in the pretrained inter type extender model 408 or the untrained inter type extender model 406.

As indicated in step 132, the training can be a locked configuration or an unlocked configuration. If the configuration is a locked configuration, the parameters of the pretrained base model 402. In a locked configuration, an augmented model training system 300 can adjust the weights of the untrained inter type extender model 406. For example, the augmented model training system 300 use an algorithm to determine the accuracy of the untrained inter type extender model 406. The augmented model training system 300 can use a backpropagation method to adjust the weights of the untrained inter type extender model 406. The weights of the pretrained base model 402 and the zero or more pretrained inter type extender models 404 can be locked, such that their weights are not adjusted.

In an unlocked configuration, the augmented model training system 300 can determine the accuracy of the untrained inter type extender model 406, the zero or more pretrained inter type extender models 404, and the pretrained base model 402. The augmented model training system 300 can use a backpropagation method to adjust the weights of the untrained inter type extender model 406, the zero or more pretrained inter type extender models 404, and the pretrained base model 402.

It should be appreciated that the techniques used herein can be used for a task other than object detection. For example, the pretrained base model 402 can trained for audio recognition and the training data can be audio signals.

The augmented model training system 300 can further store the untrained inter type extender model 406 (which has now been trained) in the model data store 212. As indicated in step 136, if the untrained inter type extender model 406 was trained using an unlocked configuration, the augmented model training system 300 can store the untrained inter type extender model 406, the zero or more pretrained inter type extender models 404, and the pretrained base model 402 in the data store. This is due to the weights of the untrained inter type extender model 406, the zero or more pretrained inter type extender models 404, and the pretrained base model 402 being adjusted during the training process. Alternatively, as indicated in step 138, if the untrained inter type extender model 406 was trained using a locked configuration, the augmented model training system 300 can store the untrained inter type extender model 406 in the model data store 212. This is because the weights of only the untrained inter type extender model 406 have been adjusted during the training process.

In either case, augmented model training system 300 can update the metadata associated with the pretrained base model 402, and the zero or more pretrained inter type extender models 404 to associate the models with the untrained inter type extender model 406. In this sense, if a user wants a machine learning model to predict a class that the untrained inter type extender model 406 has been trained to classify, the user can retrieve the corresponding pretrained base model 402, and the zero or more pretrained inter type extender models 404, if desired. Or if the user wants to add a new untrained inter type extender model (e.g., model to classify breeds of dogs), the user can retrieve the corresponding pretrained base model 402, the zero or more pretrained inter type extender models 404, and untrained inter type extender model 406.

FIG. 5 is an illustration of an example fusion layer 500, according to one or more embodiments. The fusion layer 500 can be a part of an inter type extender layer (e.g., pretrained inter type extender layer 410 or untrained inter type extender layer 418). The fusion layer 500 can use an attention mechanism to produce attention scores based on an input sequence represented as activations. For example, the fusion layer 500 can use the attention mechanism to generate key vectors and corresponding query vectors based on the input sequence. The attention mechanism can further determine a dot product of the key vectors and corresponding query vectors. The fusion layer 500 can further use a SoftMax function 502 to convert the attention scores to probability distribution. The probability distribution can indicate the relative importance of each input of an input sequence to a class. The fusion layer 500 can then generate a value vector from the input sequence. The fusion layer 500 can multiply probability distribution by the value vector to generate a weighted sum 504. The weighted sum can be passed to an inter type extender 506 to extract features from an image using the weighted sum as a guide.

The attention mechanism can determine a set of attention scores that indicate the relevance of each input of an input sequence to a class. For example, if the pretrained base model is to be trained to identify breeds of cats, the score indicates the relevance of each input of the input sequence as to breeds of cats. The Softmax function 502 can be used to convert each of these scores into a probability distribution. The probability distribution can associate each attention score with a number between 0 and 1 where the sum of the numbers equals 1. The fusion layer 500 can then generate a weighted sum 504 and transmit the weighted sum 504 to an inter type extender 506.

FIG. 6 is a process flow 600 for using an inter type extender model, according to one or more embodiments. While the operations of processes 600, 1000, 1100 and 1200 are described as being performed by generic computers, it should be understood that any suitable device may be used to perform one or more operations of these processes. Processes 600, 1000, 1100 and 1200 (described below) are respectively illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes. At 602, the computing system can identify an augmented model for performing data classification. For example, a user can provide data and a request to predict a class from the data. For example, the user can provide images of animals and a request to classify breeds of cats from the images.

At 604, the computing system can construct the model identified in 602 using a pretrained base model and one or more pretrained inter type extenders 604. For example, the computing system can access the data store 212 and search for a model that can classify breeds of cats. The computing system can identify a domain (e.g., cat) associated with breeds of cats and identity a pretrained base model that is trained to classify cats. The computing system can access metadata associated with the pretrained base model and use a mapping from the metadata associated with the pretrained base model to metadata associated with a one or more inter type extender models. The computing system can then connect the pretrained base model to the one or more inter type extender models to generate an augmented model.

At 606, the computing system can provide data to be classified as input to the augmented model constructed in 604. The data can include, for example, a set of images of animals that include one or more breeds of cats.

At 608, the computing system can receive one or more outputs by the augmented model identifying classes applicable to the input data. For example, the computing system can receive an indication that an image includes a cat from the pretrained base model. The computing system can also receive an indication of the breed of cat in the image from the one or more pretrained inter type extender models.

### Intra Type Extenders

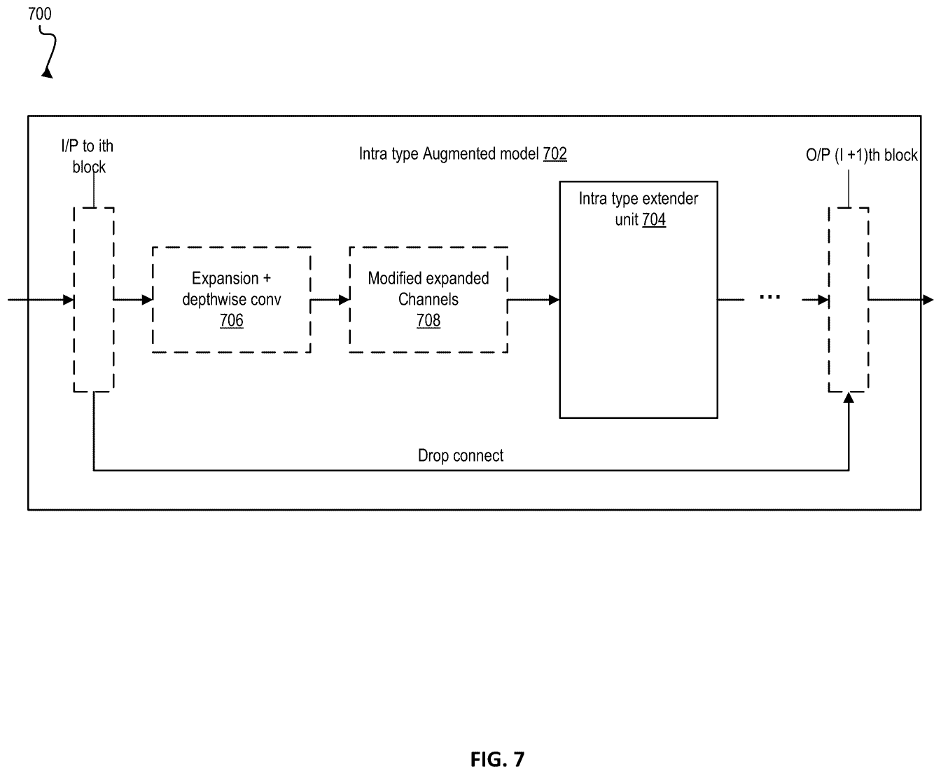

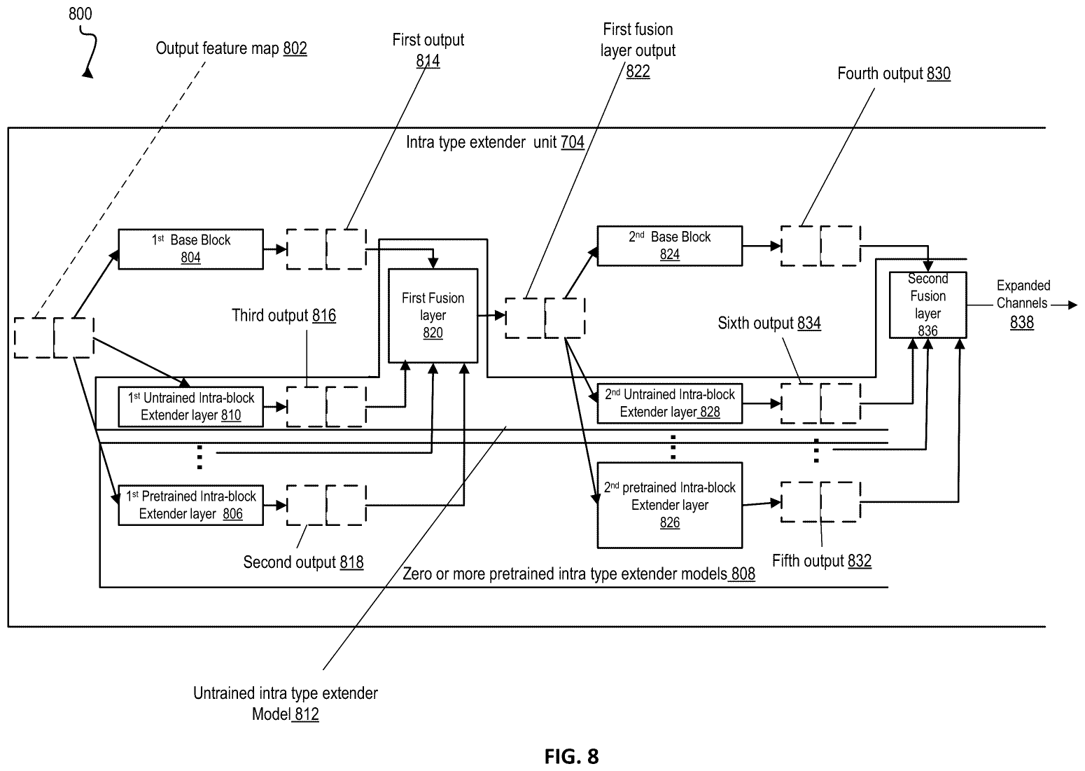

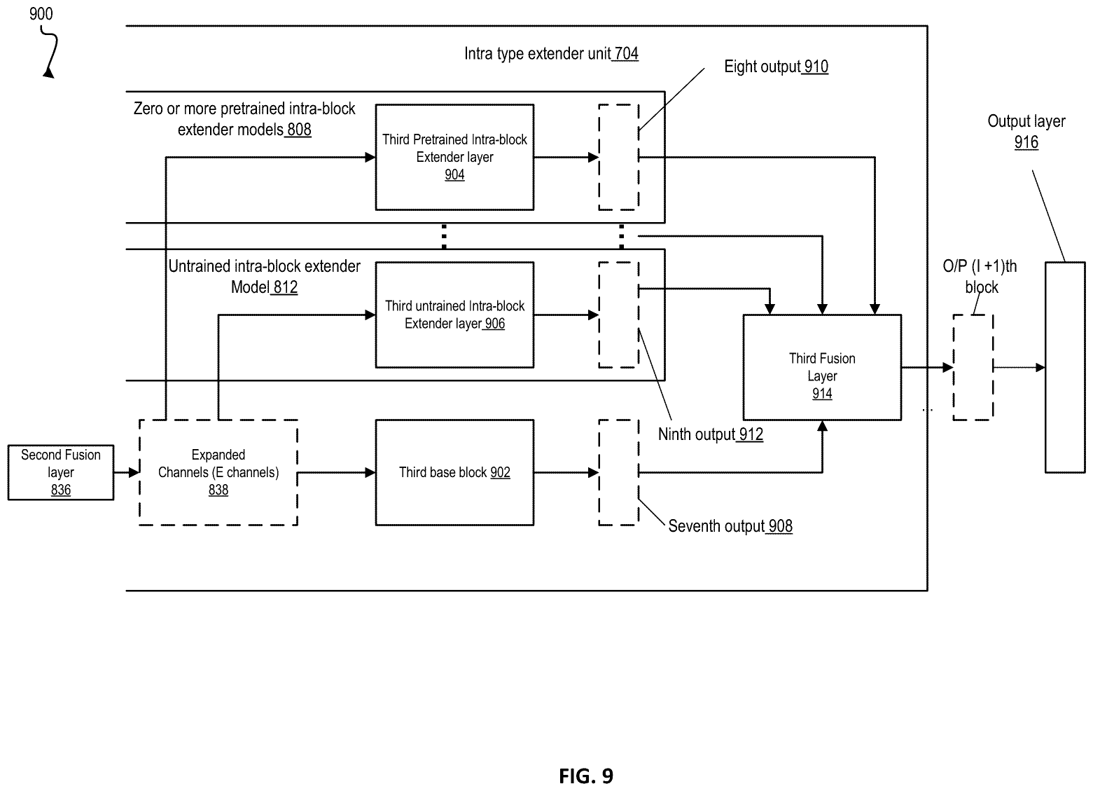

FIGS. 7-9 can be viewed together. FIG. 7 is an illustration 700 of an example convolutional neural network, according to one or more embodiments. In particular, FIG. 7 is an illustration of portion of a Mobile-Net V3 architecture with an intra type extender unit. It should be appreciated that FIG. 7 is provided for illustration purposes and the intra type extenders are compatible with various neural networks. FIG. 8 is an illustration of a portion of an intra type extender unit, according to one or more embodiments. FIG. 9 is an illustration of an example portion of an intra type extender unit, according to one or more embodiments. As opposed to inter type extenders, where the internal activations of the backbone and previous inter type branches remain constant, the addition of intra type extenders to the base architecture results in alterations of the output activations that suits the new task dataset. In other words, the supplementary task-specific parameters are fused within the pretrained base model at multiple instances before yielding the final block output.

The computing system can create an intra type augmented model 702 by connecting a pretrained base model to zero or more pretrained intra type extender models and to an untrained intra type extender model to a pretrained base model. The zero or more pretrained intra type extender models and the untrained intra type extender model are described with more specificity with respect to FIGS. 8 and 9. Collectively the zero or more pretrained intra type extender models and the untrained intra type extender model are illustrated as the intra type extender unit 704 in FIG. 7.

The intra type augmented model 702 can be trained by the augmented model training system 300, as indicated in 158. The intra type augmented model 702 can receive the custom classes training dataset 302 via the augmented model training system 300. In this example, rather than images of cats and dogs, the custom classes training dataset 302 can include images of horses. In some embodiments, the intra type augmented model 702 can, upon receiving an image, perform operations for expansions and depthwise convolutions 706, in which different filters are used for each input channel, where an input channel can correspond to a feature of the input. For example, for an image an input channel can correspond to a pixel color (e.g., red, green, and blue). The intra type augmented model 702 can include a filter for each color. For an audio training instance, the inputs channels may correspond to different frequency bands and the intra type augmented model 702 can include a filter for different frequency bands. In some instances, this operation can lead to a number of modified expanded channels 708. For example, for an image, the channels can be expanded to include additional colors (e.g., yellow, black, etc.) The modified expanded channels 708 can be received by the intra type extender unit 704, which is described with more particularly with respect to FIGS. 8 and 9. The continuation of the process is further described further with respect to FIGS. 8 and 9.

FIG. 8 is an illustration of a portion 800 of an example intra type extender unit 704, according to one or more embodiments. In some embodiments, an adaptive average pooling operation is applied to each channel of the modified expanded channels 708 to modify the spatial dimensions of each channel to a desired spatial dimension. For example, the input channels can each be represented by an input feature map, upon which an adaptive average pooling operation is applied. The intra type augmented model 702 can further access a desired output feature map size. The intra type augmented model 702 can further determine the dimensions of the output feature map based on the desired map size and perform pooling operation (e.g., adaptive average pooling operation). For each region of the output feature map, the neural network can determine a value that correspond to a region of the input feature map. The intra type augmented model 702 can then generate the output feature map 802 based on the determination. The output feature map 802 can be used as inputs and propagated to a first base block 804, and first pretrained intra type extender layer 806 of zero or more pretrained intra type extender models 808, and a first untrained intra type extender layer 810 of an untrained intra type extender model 812. It should be appreciated that in some embodiments, there are no pretrained inter type extender models. For example, if no pretrained inter type extender model is identified at step 150, then there is no pretrained inter type extender model.

As illustrated, the output feature map 802 is propagated through the first base block 804, the first untrained intra type extender layer 810, and the first untrained intra type extender layer. The first base block 804, the first pretrained intra type extender layer 806, and the first untrained intra type extender layer 810 can each include a respective filter or filters that can process the output feature map 802 based on the class upon which each is trained or to be trained. For example, if the first base block 804 is pretrained to classify a horse in an image, the first base block 804 can use a filter(s) to process the output feature map features related to a horse. If the first pretrained intra type extender layer 806 is pretrained for classifying breeds of zebras, then the first pretrained intra type extender layer 806 can use a filter(s) to identify features related to breeds of zebras. If the first untrained intra type extender layer 810 is to be trained to classify breeds of horses, then the first untrained intra type extender layer 810 can process the output feature map 802 for features associated with breeds of horses. Each of the outputs (e.g., first output 814, second output 816, and third output 818) of first base block 804, the first pretrained intra type extender layer 806, and the first untrained intra type extender layer 810 can be transmitted to a first fusion layer 820. As illustrated, in contrast to the inter type augmented model 400, the outputs are transmitted to a common first fusion layer 820. Furthermore, the first fusion layer 820 is to be trained for classification of the new class (e.g., breeds of horses). Therefore, the first fusion layer 820 can be trained to generate a common set of attention scores that are associated with a desired new class. The first fusion layer 820 can further generate a probability distribution based on the attention scores, and further generate a weighted sum based on the probability distribution.

The first fusion layer 820 can transmit a first fusion layer output 822 (e.g., weighted sum) to a second base block 824, a second pretrained intra type extender layer 826, and a second untrained intra type extender layer 828. The second base block 824, the second pretrained intra type extender layer 826, and the second untrained intra type extender layer 828 can perform functions similar to the first base block 804, the first pretrained intra type extender layer 806, and the first untrained intra type extender layer 810. However, given the first fusion layer output 822, the second base block 824, the second pretrained intra type extender layer 826, and the second untrained intra type extender layer 828 may determine deeper correspondences between the features and the new class using the weighted sum. The second base block 824, the second pretrained intra type extender layer 826, and the second untrained intra type extender layer 828 can transmit their outputs (e.g., fourth output 830, fifth output 832, and sixth output 834) to a second fusion layer 836. The second fusion layer 836 can function similarly to the first fusion layer 820.

The intra type augmented model 702 can then engage in channel wise multiply operation, such that an element wise multiplication is performed between an output outputted by the second fusion layer 836 and channel-wise multipliers. The operation can be performed for feature modulation that allows the intra type augmented model 702 to emphasize one or more channels over other channels. For example, the intra type augmented model 702 can use the channel wise multiply operation to emphasize channels that correspond more greatly to the new class (e.g., breeds of horses). The channel wise multiply operation can result in a set of expanded channels 838.

FIG. 9 is an illustration of an example portion 900 of an intra type extender unit, according to one or more embodiments. FIG. 9 is illustrated as a continuation of the intra type extender unit 704 of FIG. 8. This set of expanded channels 838 can be transmitted to a third base block 902, a third pretrained intra type extender layer 904 and a third untrained intra type extender layer 906. The third base block 902, the third pretrained intra type extender layer 904 and the third untrained intra type extender layer 906 can function similarly to the second base block 824, the second pretrained intra type extender layer 826, and the second untrained intra type extender layer 828. The third base block 902, the third pretrained intra type extender layer 904 and the third untrained intra type extender layer 906 can further transmit outputs (e.g., a seventh output 908, an eighth output 910, and a ninth output 912) to a third fusion layer 914. The third fusion layer can function similarly to the second fusion layer 836. It should be appreciated that as illustrated, the intra type extender unit 704 includes three fusion layers. One of ordinary skill the art can contemplate that the intra type extender unit 704 can include various numbers of fusion layers to accomplish the functionality described herein. The output of the third fusion layer 914 can be transmitted for downstream processing by the intra type augmented model 702.

The intra type augmented model 702 can include an output layer 916 for outputting a prediction as to the new class (e.g., breed of horse). For example, the output layer 916 can generate a prediction as to a breed of the horse that is shown on an image from the custom classes training dataset 302.

The augmented model training system 300 can use an algorithm to determine the accuracy of the intra type augmented model 702. The augmented model training system 300 can compare the accuracy to a threshold accuracy. The augmented model training system 300 can use a backpropagation method to adjust the weights of the intra type augmented model 702 to improve the accuracy. As indicated in step 158, the training can be a locked configuration or an unlocked configuration. If the training is a locked configuration, only the weights of the untrained intra type extender model 812 are adjusted. If, however, the training is in an unlocked configuration, the weights of the base model (e.g., first base block 804, second base block 824, and third base block 902), the zero or more pretrained intra type extender models 808 and the untrained intra type extender model 812 are adjusted by the augmented model training system 300.

If the training was an unlocked configuration, the augmented model training system 300 can store the base model, the zero or more pretrained intra type extender models 808 and the untrained intra type extender model 812 (now trained) in the data store 212 as indicated in 162. If the training was a locked configuration, the augmented model training system 300 can store the untrained intra type extender model 812 (now trained) in the data store 212 as indicated in 164. The augmented model training system 300 can then update the metadata associated with the base model to indicate the creation of intra type augmented model 702, including the zero or more pretrained intra type extender models 808 and the untrained intra type extender model 812 (now trained).

At some point, a user may wish to access the untrained intra type extender model 812 (now trained). For example, the user may wish for a model that can classify breeds of horses from input images. The computing system can access the data store, and based on the metadata, identify the untrained intra type extender model 812 (now trained). For example, the computing system can use a keyword search or other appropriate search method to identify the untrained intra type extender model 812 (now trained). In this instance, the computing system may retrieve the base model, the zero or more pretrained intra type extender models 808 and the untrained intra type extender model 812 (now trained) from the data store 212. This is because the fusion layers (e.g., first fusion layer 820, second fusion layer 836, and third fusion layer 914) have not been trained for identification of different classes as with the inter type augmented model 400. Rather the fusion layers have been trained using outputs from a base block, pretrained intra type extender layer, if any, and untrained intra type extender layer to generate a common output for the new class. Each fusion layer's output accounts for receiving an output from the base model, the zero or more pretrained intra type extender models 808 and the untrained intra type extender model 812. Therefore, the untrained intra type extender model 812 cannot be decoupled from the base model and the zero or more pretrained intra type extender models 808, if any.

The embodiments described-herein provide a single-stage CL training approach that is viable for an industrial custom modeling setting using effectively lesser training resources. The embodiments remove a neural network's dependency on previous task datasets given by the customer. The embodiments described-herein enables the creation of a meta-store/model-store to have domain-specific model blocks. The embodiments herein can be used to create a target model on-the-fly by selectively combining task-specific parameters from their respective domains. The embodiments described-herein, further offers fine-grained control to customers over the selection and fusion of domain and task-specific parameters from past iterations. The embodiments described-herein can continuously improve performance on the target domain without impacting performance on the previous tasks and datasets. The embodiments described-herein can reduce the overall cost of adoption for customers in terms of time, effort, and financial resources.

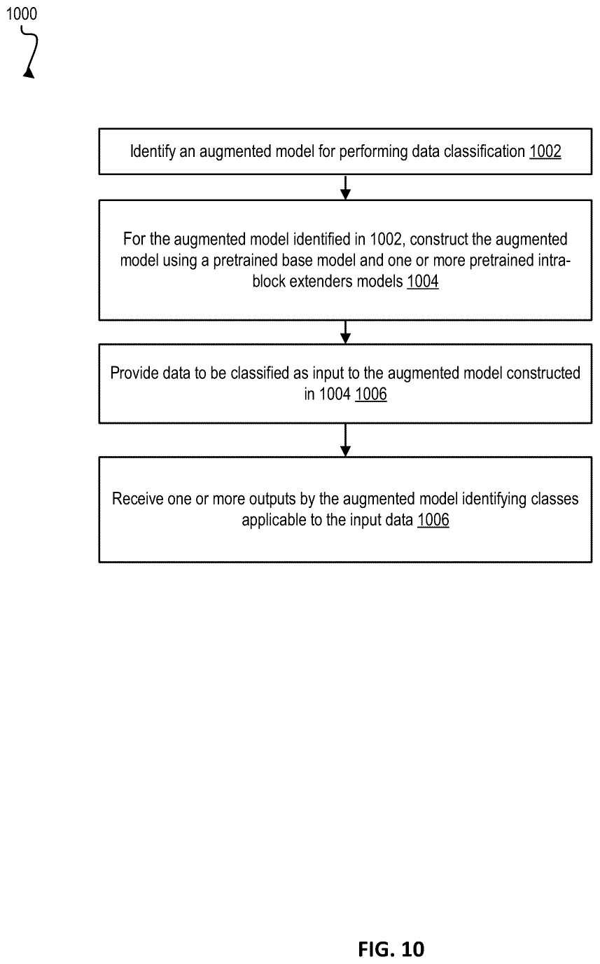

FIG. 10 is a process flow 1000 for using an inter type extender model, according to one or more embodiments. At 1002, the computing system can identify an augmented model for performing data classification. For example, a user can provide data and a request to predict a class from the data. For example, the user can provide images of animals and a request to classify breeds of horses from the images.

At 1004, the computing system can construct the model identified in 1002 using a pretrained base model and one or more pretrained intra type extenders. For example, the computing system can access the model data store 212 and search for a model that can classify breeds of horses. The computing system can identify a domain (e.g., horse) associated with breeds of horses and identity a pretrained base model that is trained to classify horses. The computing system can access metadata associated with the pretrained base model and use a mapping from the metadata associated with the pretrained base model to metadata associated with one or more intra type extender models. The computing system can then connect the pretrained base model to the one or more intra type extender models to generate an augmented model.

At 1006, the computing system can provide data to be classified as input to the augmented model constructed in 1004. The data can include, for example, a set of images of animals that include one or more breeds of horses.

At 1008, the computing system can receive one or more outputs by the augmented model identifying classes applicable to the input data. For example, the computing system can receive an indication of a breed of one or more horses included in an image.

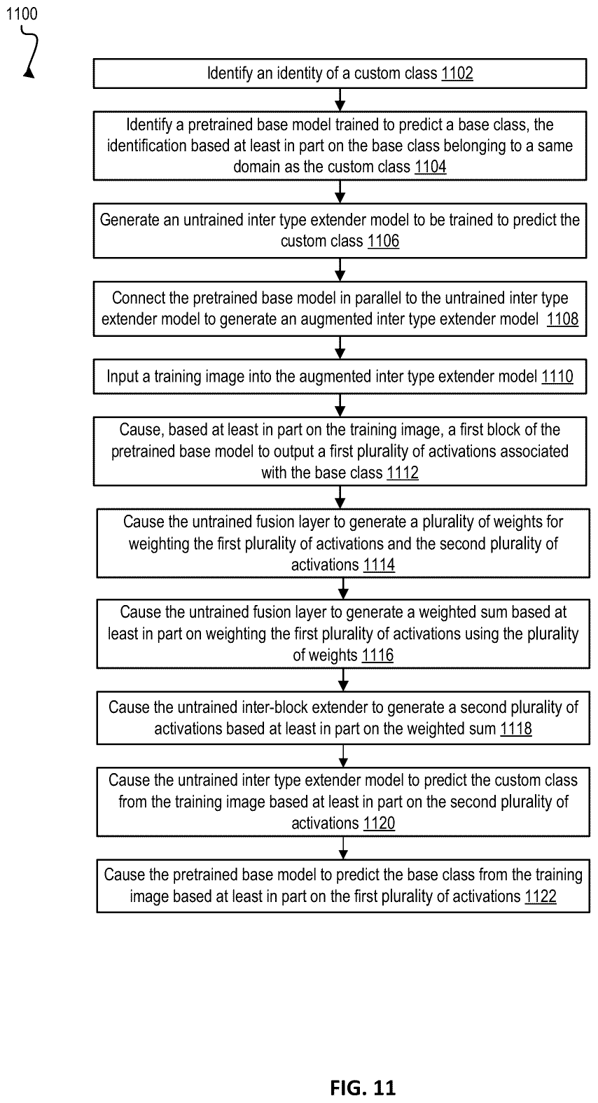

FIG. 11 is an example process flow 1100 for training an inter type extender model, according to one or more embodiments. At 1102, a computing system (e.g., augmented model training system) can identify a custom class. For example, the computing system can receive a request for a model that can classify the custom class.

At 1104, the computing system can select a pretrained base model trained to predict a base class. The selection can be based at least in part on the base class belonging to a same domain as the custom class. For example, the computing system can determine a domain associated with the custom class and access a data store. The computing system can further map the domain custom class to a domain identified by metadata that is associated with the pretrained base model.

At 1106, the computing system can generate an untrained inter type extender model to be trained to predict the custom class from data points associated with the custom class. The untrained inter type extender model can include an untrained fusion layer and an untrained inter type extender. For example, if the computing system is unable to identify a pretrained model, then the computing system can determine to train an augmented model.

At 1108, the computing system can connect the pretrained base model in parallel to the untrained inter type extender model to generate an inter type augmented model. The pretrained model can be connected such that a first block of the pretrained base model is connect to a fusion layer of the untrained inter type extender model as indicated above.

At 1110, the computing system can input a training image into the inter type augmented model, the training image comprising the data points associated with the custom class. The training image can be image from the custom classes training dataset 302.

At 1112, the computing system can cause, based at least in part on the training image, a first block of the pretrained base model to output a first set of activations associated with the base class. The pretrained base model can pass the image through a set of convolutional layers and output an input sequence represented by the activations.

At 1114, the computing system can cause the untrained fusion layer to generate a set of weights for weighting the first set of activations, the set of weights configured to cause the untrained inter type extender model to identify the custom class from the training image. The untrained fusion layer can use an attention mechanism to generate the set of weights configured to cause the untrained inter type extender model to identify the custom class from the training image.

At 1116, the computing system can cause the untrained fusion layer to generate a weighted sum based at least in part on weighting the first set of activations using the set of weights. The untrained fusion layer can generate a value vector based on the output of the first block. The untrained fusion layer can further multiply the set of weights by the value vector to generate the weighted sum.

At 1118, the computing system can cause the untrained inter type extender to generate a second set of activations based at least in part on the weighted sum. The untrained inter type extender can pass the image through a set of convolutional layers using the weighted sum as a guide to generate the second set of activations.

At 1120, the computing system can cause the untrained inter type extender model to predict the custom class from the training image based at least in part on the second set of activations. At 1122, the computing system can cause the pretrained base model to predict the base class from the training image based at least in part on the first set of activations.

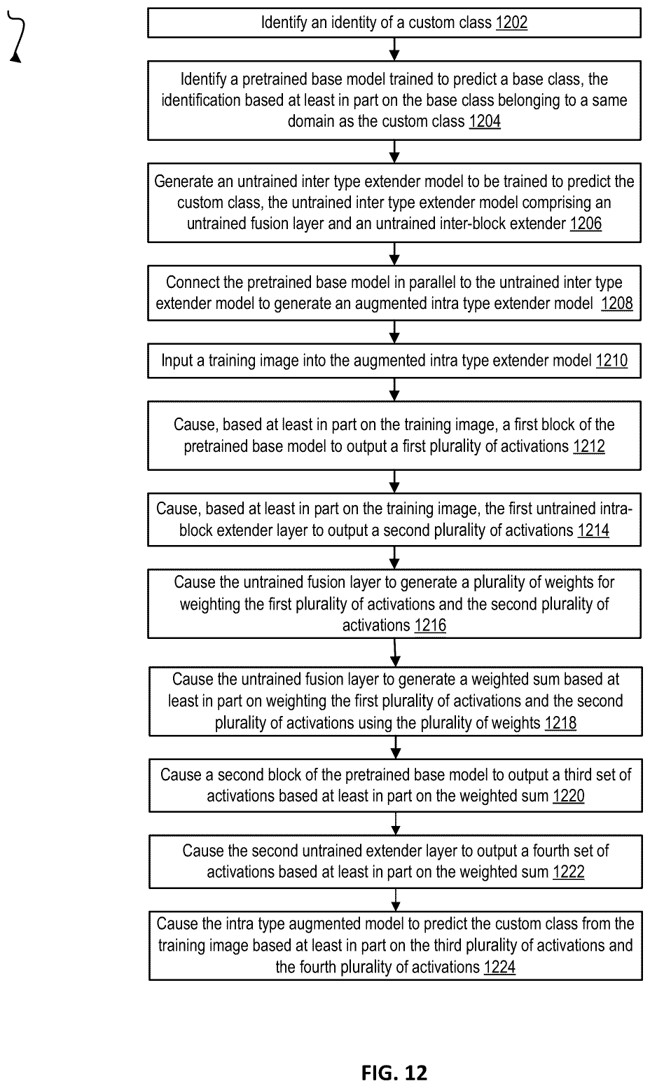

FIG. 12 is an example process flow 1200 for training an intra type extender model, according to one or more embodiments. At 1202, a computing system (e.g., augmented model training system) can identify a custom class.

At 1204, the computing system can select a pretrained base model trained to predict a base class. The selection can be based at least in part on the base class belonging to a same domain as the custom class. For example, the computing system can determine a domain associated with the custom class and access a data store. The computing system can further map the domain custom class to a domain identified by metadata that is associated with the pretrained base model.

At 1206, the computing system can generate an untrained intra type extender model to be trained to identify the custom class from data points associated with the custom class, the untrained intra type extender model comprising an untrained fusion layer, a first untrained intra type extender layer and a second untrained extender layer.

At 1208, the computing system can connect the intra type extender machine learning model to the pretrained base machine learning model to generate an intra type augmented model The pretrained model can be connected such that a first block of the pretrained base model and an intra type extender are connected to a common fusion layer as indicated above.

At 1210, the computing system can input a training image to the intra type augmented model, the training image comprising the data points associated with the custom class.

At 1212, the computing system can cause, based at least in part on the training image, a first block of the pretrained base model to output a first plurality of activations. The first block of the pretrained base model can pass the image through a set of convolutional layers and output an input sequence represented by the activations to be received by the common fusion layer.

At 1214, the computing system can cause, based at least in part on the training image, the first untrained intra type extender layer to output a second plurality of activations. The first untrained intra type extender layer can pass the image through a set of convolutional layers and output an input sequence represented by the activations to be received by the common fusion layer.

At 1216, the computing system can cause the untrained fusion layer to generate a plurality of weights for weighting the first plurality of activations and the second plurality of activations, the plurality of weights configured to cause the intra type augmented model to identify the custom class from the training image.

At 1218, the computing system can cause the untrained fusion layer to generate a weighted sum based at least in part on weighting the first plurality of activations and the second plurality of activations using the plurality of weights. The common fusion layer can generate a value vector based on the output of the first block. The untrained fusion layer can further multiply the set of weights by the value vector to generate the weighted sum.

At 1220, the computing system can cause a second block of the pretrained base model to output a third plurality of activations based at least in part on the weighted sum, and at 1222, the computing system can cause the second untrained extender layer to output a fourth plurality of activations based at least in part on the weighted sum.

At 1222, the computing system can cause the intra type augmented model to predict the custom class from the training image based at least in part on the third plurality of activations and the fourth plurality of activations. For example, the intra type augmented model can predict a breed of horse in an image.

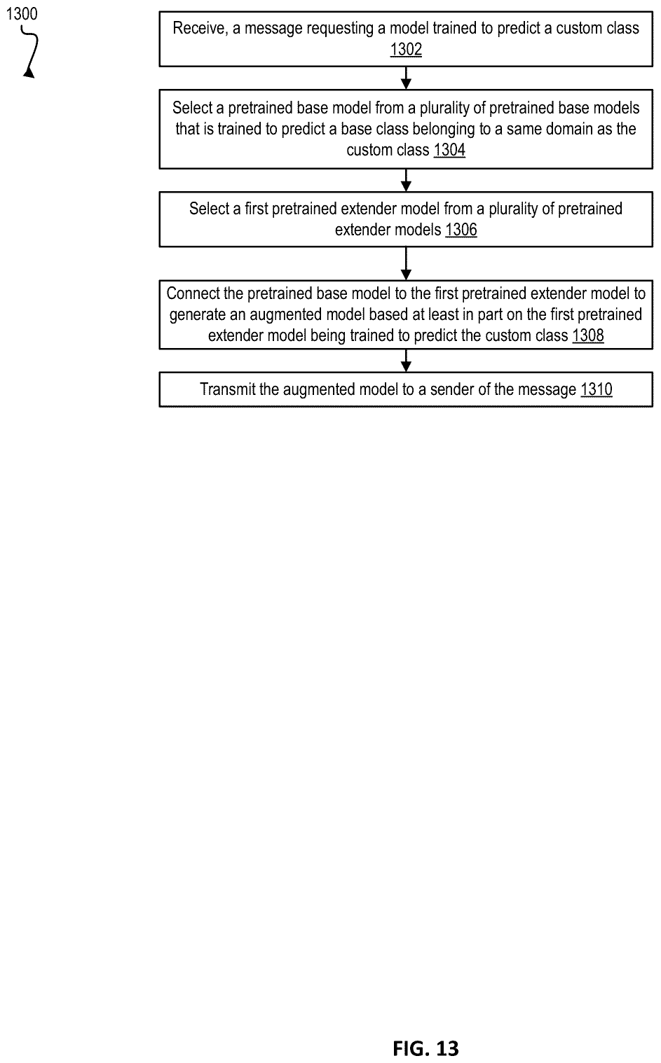

FIG. 13 is an example process flow 1300 for maintaining a data store, according to one or more embodiments. At 1302, a computing system (e.g., data store 212) can receive a message requesting a model trained to predict a custom class. For example, the computing system can receive a user request for a model that can predict the custom class.

At 1304, the computing system can select a pretrained base model from a plurality of pretrained base models that is trained to predict a base class belonging to a same domain as the custom class. For example, the computing system can determine a domain associated with the custom class. The computing system can further map the domain custom class to a domain identified by metadata that is associated with the pretrained base model.

At 1306, the computing system can select a first pretrained extender model from a plurality of pretrained extender models. The first pretrained extender model can be associated with the pretrained base model based at least in part on selecting the pretrained base model. The first pretrained extender model can be trained to predict the custom class.

At 1308, the computing system can connect the pretrained base model to the first pretrained extender model to generate an augmented model based at least in part on the first pretrained extender model being trained to predict the custom class. The pretrained base model can connected to the first pretrained extender model such that a first output of a first block of the pretrained base model is received by a first pretrained fusion layer of the pretrained extender model.

At 1310, the computing system can transmit the augmented model to a sender of the message.

### EXAMPLES

In the following sections, further exemplary embodiments are provided.

Example 1 includes a method, comprising: identifying, by a computing system, a custom class; selecting, by a computing system, a pretrained base model trained to predict a base class, the selection based at least in part on the base class belonging to a same domain as the custom class; generating, by the computing system, an untrained inter type extender model to be trained to predict the custom class from data points associated with the custom class, the untrained inter type extender model comprising an untrained fusion layer and an untrained inter type extender; connecting, by the computing system, the pretrained base model in parallel to the untrained inter type extender model to generate an inter type augmented model; inputting, by the computing system, a training image into the inter type augmented model, the training image comprising the data points associated with the custom class; causing, by computing system and based at least in part on the training image, a first block of the pretrained base model to output a first plurality of activations associated with the base class; causing, by the computing system, the untrained fusion layer to generate a plurality of weights for weighting the first plurality of activations, the plurality of weights configured to cause the untrained inter type extender model to identify the custom class from the training image; causing, by the computing system, the untrained fusion layer to generate a weighted sum based at least in part on weighting the first plurality of activations using the plurality of weights; causing, by the computing system, the untrained inter type extender to generate a second plurality of activations based at least in part on the weighted sum; causing, by the computing system, the untrained inter type extender model to predict the custom class from the training image based at least in part on the second plurality of activations; and causing, by the computing system, the pretrained base model to predict the base class from the training image based at least in part on the first plurality of activations.

Example 2 includes the method of example 1, wherein the method further comprises: generating a plurality of vectors based at least in part on the training image; generating a plurality of activation scores based at least in part on the vectors; and generating a probability distribution based at least in part on the plurality of activation scores, wherein the probability distribution comprises the plurality of weights.

Example 3 includes the method of any of examples 1 and 2, wherein the inter type augmented model is trained using a locked configuration, and wherein the method further comprises: determining an accuracy of the untrained inter type extender model based at least in part on a loss function; and adjusting a plurality of untrained inter type extender model weights based at least in part on the accuracy, wherein a plurality of pretrained base model weights remain unadjusted.

Example 4 includes the method of any of examples 1 and 2, wherein the inter type augmented model is trained using an unlocked configuration, and wherein the method further comprises: determining an accuracy of the untrained inter type extender model based at least in part on a loss function; adjusting a plurality of pretrained base model weights based at least in a part on the accuracy; and adjusting a plurality of untrained inter type extender model weights based at least in a part on the accuracy.

Example 5 includes the method of any of examples 1-4, wherein the method further comprises: accessing a data store that stores the pretrained base model; identifying a pretrained inter type extender model based at least in part on metadata stored in the data store and associated with the pretrained inter type extender model, wherein the pretrained inter type extender model is trained to identify a class belonging to the same domain as the custom class; and connecting the pretrained inter type extender model to the pretrained base model and untrained inter type extender model.

Example 6 includes the method of example 5, wherein the method further comprises: transmitting, in response to the untrained inter type extender model identifying the custom class from the training image, first control instructions to a data store to store the untrained inter type extender model; and transmitting second control instructions to the data store to update metadata associated with the pretrained base model to indicate generation of the inter type augmented model.

Example 7 includes the method of any of examples 1-6, wherein the method further comprises: determining whether to generate the inter type augmented model based at least in part on the custom class.

Example 8 includes a computing system comprising one or more processors; and one or non-transitory computer-readable media comprising a sequence of instructions which, when executed on the one or more processors, cause the one or more processors to perform any of the steps of examples 1-7.

Example 9 includes one or more non-transitory computer-readable media comprising a sequence of instructions that, when executed by one or more processors, cause a computing system to perform any of the steps of examples 1-7.

Example 10 includes a computing system comprising: one or more processors; and one or non-transitory computer-readable media comprising a sequence of instructions which, when executed on the one or more processors, cause the one or more processors to: identify an identity of a custom class; select a pretrained base model trained to predict a base class, the selection based at least in part on the base class belonging to a same domain as the custom class; generate an untrained intra type extender model to be trained to identify the custom class from data points associated with the custom class, the untrained intra type extender model comprising an untrained fusion layer, a first untrained intra type extender layer and a second untrained extender layer; connect the untrained intra type extender model to the pretrained base model to generate an intra type augmented model; input a training image to the intra type augmented model, the training image comprising the data points associated with the custom class; cause, based at least in part on the training image, a first block of the pretrained base model to output a first plurality of activations; cause, based at least in part on the training image, the first untrained intra type extender layer to output a second plurality of activations; cause the untrained fusion layer to generate a plurality of weights for weighting the first plurality of activations and the second plurality of activations, the plurality of weights configured to cause the intra type augmented model to identify the custom class from the training image; cause the untrained fusion layer to generate a weighted sum based at least in part on weighting the first plurality of activations and the second plurality of activations using the plurality of weights; cause a second block of the pretrained base model to output a third plurality of activations based at least in part on the weighted sum; cause the second untrained extender layer to output a fourth plurality of activations based at least in part on the weighted sum; cause the intra type augmented model to predict the custom class from the training image based at least in part on the third plurality of activations and the fourth plurality of activations.

Example 11 includes the computing system of example 10, wherein sequence of instructions which, when executed on the one or more processors, further cause the one or more processors to: generate a plurality of vectors based at least in part on the training image; generate a plurality of activation scores based at least in part on the vectors; and generate a probability distribution based at least in part on the plurality of activation scores, wherein the probability distribution comprises the plurality of weights.

Example 12 includes the computing system of example 11, wherein the intra type augmented model is trained using a locked configuration, and wherein sequence of instructions which, when executed on the one or more processors, further cause the one or more processors to: determine an accuracy of the untrained intra type extender model based at least in part on a loss function; and adjust a plurality of untrained intra type extender model weights based at least in part on the accuracy, wherein a plurality of pretrained base model weights remain unadjusted.

Example 13 includes the computing system of example 11, wherein the intra type augmented model is trained using an unlocked configuration, and wherein sequence of instructions which, when executed on the one or more processors, further cause the one or more processors to: determine an accuracy of the untrained intra type extender model based at least in part on a loss function; adjust a plurality of pretrained base model weights based at least in a part on the accuracy; and adjust a plurality of untrained intra type extender model weights based at least in a part on the accuracy.

Example 14 includes the computing system of any of examples 10-13, wherein the sequence of instructions which, when executed on the one or more processors, further cause the one or more processors to: access a data store that stores the pretrained base model; identify a pretrained intra type extender model based at least in part on metadata stored in the data store and associated with the pretrained intra type extender model, wherein the pretrained intra type extender model is trained to identify a class belonging to the same domain as the custom class; and connect the pretrained intra type extender model to the pretrained base model and untrained intra type extender model.

Example 15 includes the computing system of example 14, wherein the sequence of instructions which, when executed on the one or more processors, further cause the one or more processors to: transmit, in response to the untrained intra type extender model identifying the custom class from the training image, first control instructions to a data store to store the untrained intra type extender model; and transmit second control instructions to the data store to update metadata associated with the pretrained base model to indicate generation of the intra type augmented model.

Example 16 includes the computing system of any of examples 10-15, wherein the sequence of instructions which, when executed on the one or more processors, further cause the one or more processors to: determine whether to generate the intra type augmented model based at least in part on the custom class.

Example 17 includes a method for performing any of the steps of examples 10-16.

Example 18 includes one or more non-transitory computer-readable media comprising a sequence of instructions that, when executed by one or more processors, cause a computing system to perform any of the steps of examples 10-16.

Example 19 includes one or more non-transitory computer-readable media comprising a sequence of instructions that, when executed by one or more processors, cause a computing system to: identify a custom class; select a pretrained base model trained to predict a base class, the selection based at least in part on the base class belonging to a same domain as the custom class; generate an untrained inter type extender model to be trained to predict the custom class from data points associated with the custom class, the untrained inter type extender model comprising an untrained fusion layer and an untrained inter type extender; connect the pretrained base model in parallel to the untrained inter type extender model to generate an inter type augmented model; input a training image into the inter type augmented model, the training image comprising the data points associated with the custom class; cause, based at least in part on the training image, a first block of the pretrained base model to output a first plurality of activations associated with the base class; cause the untrained fusion layer to generate a plurality of weights for weighting the first plurality of activations, the plurality of weights configured to cause the untrained inter type extender model to identify the custom class from the training image; cause the untrained fusion layer to generate a weighted sum based at least in part on weighting the first plurality of activations using the plurality of weights; cause the untrained inter type extender to generate a second plurality of activations based at least in part on the weighted sum; cause the untrained inter type extender model to predict the custom class from the training image based at least in part on the second plurality of activations; and cause the pretrained base model to predict the base class from the training image based at least in part on the first plurality of activations.

Example 20 includes the one or more non-transitory computer-readable media of example 19, wherein the sequence of instructions which, when executed on the one or more processors, further cause the one or more processors to: generate a plurality of vectors based at least in part on the training image; generate a plurality of activation scores based at least in part on the vectors; and generate a probability distribution based at least in part on the plurality of activation scores, wherein the probability distribution comprises the plurality of weights.

Example 21 includes the one or more non-transitory computer-readable media of example 20, wherein the inter type augmented model is trained using a locked configuration, and wherein the sequence of instructions which, when executed on the one or more processors, further cause the one or more processors to: determine an accuracy of the untrained inter type extender model based at least in part on a loss function; and adjust a plurality of weights of the untrained inter type extender model based at least in part on the accuracy, wherein weights of the pretrained base model remain unadjusted.

Example 22 includes the one or more non-transitory computer-readable media of example 20, wherein the inter type augmented model is trained using an unlocked configuration, and wherein the sequence of instructions which, when executed on the one or more processors, further cause the one or more processors to: determine an accuracy of the untrained inter type extender model based at least in part on a loss function; adjust a plurality of pretrained base model weights based at least in a part on the accuracy; and adjust a plurality of untrained inter type extender model weights based at least in a part on the accuracy.

Example 23 includes the one or more non-transitory computer-readable media of any of examples 19-22, wherein the sequence of instructions which, when executed on the one or more processors, further cause the one or more processors to: access a data store that stores the pretrained base model; identify a pretrained inter type extender model based at least in part on metadata stored in the data store and associated with the pretrained inter type extender model, wherein the pretrained inter type extender model is trained to identify a class belonging to the same domain as the custom class; and connect the pretrained inter type extender model to the pretrained base model and untrained inter type extender model.

Example 24 includes the one or more non-transitory computer-readable media of any of examples 19-23, wherein the sequence of instructions which, when executed on the one or more processors, further cause the one or more processors to: transmit, in response to the untrained inter type extender model identifying the custom class from the training image, first control instructions to a data store to store the untrained inter type extender model; and transmit second control instructions to the data store to update metadata associated with the pretrained base model to indicate generation of the inter type augmented model.

Example 25 includes a method for performing any of the steps of examples 19-24.

Example 26 includes a computing system comprising one or more processors; and one or non-transitory computer-readable media comprising a sequence of instructions which, when executed on the one or more processors, cause the one or more processors to perform any of the steps of examples 19-24.

Example 27 includes a method, comprising: receiving, by a data store, a message requesting a model trained to predict a custom class; selecting, by the data store, a pretrained base model from a plurality of pretrained base models that is trained to predict a base class belonging to a same domain as the custom class; selecting, by the data store, a first pretrained extender model from a plurality of pretrained extender models, the first pretrained extender model associated with the pretrained base model based at least in part on selecting the pretrained base model, the first pretrained extender model trained to predict the custom class; connecting, by the data store, the pretrained base model to the first pretrained extender model to generate an augmented model based at least in part on the first pretrained extender model being trained to predict the custom class, the pretrained base model connected to the first pretrained extender model such that a first output of a first block of the pretrained base model is received by a first pretrained fusion layer of the pretrained extender model; and transmitting, by the data store, the augmented model to a sender of the message.

Example 28 includes the method of example 27, wherein the method further comprises: receiving a message indicating that the pretrained base model was used to train a second pretrained extender model, the second pretrained extender model trained to predict a class belonging to the same domain as the base class and the custom class; generating metadata to associate the pretrained base model with the second pretrained extender model; identifying the second pretrained extender model based at least in part on the metadata; and connecting the second pretrained extender model to the pretrained base model, wherein the augmented model comprises the pretrained base model, the first pretrained extender model, and the second pretrained extender model.

Example 29 includes the method of example 28, wherein selecting the pretrained base model from a plurality of pretrained base models that is trained to predict a base class belonging to a same domain as the custom class comprises: accessing first metadata stored in the data store and associated with the pretrained base model, wherein the first metadata comprises an identity of the base class; and determining, using a mapping, an association between the base class and the custom class based at least in part on the first metadata and the message, wherein the pretrained base model is selected based at least in part on the association.

Example 30 includes the method of any of examples 27-29, wherein selecting the first pretrained extender model from the plurality of pretrained extender models comprises: accessing first metadata stored in the data store and associated with the pretrained base model, wherein the first metadata comprises an identity of the base class; accessing second metadata stored in the data store and associated with the first pretrained extender model, wherein the second metadata comprises an identity of the custom class; and determining, using a mapping, an association between the base class and the custom class based at least in part on the first metadata and the second metadata, wherein the first pretrained extender model is selected based at least in part on the association.

Example 31 includes the method of any of examples 27-30, wherein the augmented model is an inter type augmented model, and wherein connecting the pretrained base model to the first pretrained extender model to generate the augmented model comprises: connecting the first pretrained fusion layer to an input interface of the augmented model for receiving a training instance, such that the first pretrained fusion layer is configured to receive the output of the first block and the training instance; connecting the first pretrained fusion layer to a first pretrained inter type extender of the first pretrained extender model; and connecting, the first pretrained inter type extender to a second pretrained fusion layer of the of the first pretrained extender model.

Example 32 includes the method of any of examples 27-31, wherein the augmented model is an intra type augmented model, and wherein connecting the pretrained base model to the first pretrained extender model to generate an augmented model comprises: connecting a first pretrained intra type extender layer to the first pretrained fusion layer, such that a second output of the first pretrained intra type extender layer; and connecting, the first pretrained fusion layer to a second block of the pretrained base model and a second pretrained intra type extender layer, such that a third output of the first pretrained fusion layer is received by the second block and the second pretrained intra type extender layer.

Example 32 includes the method of any of examples 27-32, wherein the method further comprises: generating metadata indicating the generation of the augmented model; and storing the metadata in the data store.

Example 33 includes a computing system comprising one or more processors; and one or non-transitory computer-readable media comprising a sequence of instructions which, when executed on the one or more processors, cause the one or more processors to perform any of the steps of examples 27-33.

Example 34 includes one or more non-transitory computer-readable media comprising a sequence of instructions that, when executed by one or more processors, cause a computing system to perform any of the steps of examples 27-33.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 14 is a block diagram 1400 illustrating an example pattern of an IaaS architecture, according to at least one embodiment. Service operators 1402 can be communicatively coupled to a secure host tenancy 1404 that can include a virtual cloud network (VCN) 1406 and a secure host subnet 1408. In some examples, the service operators 1402 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1406 and/or the Internet.

The VCN 1406 can include a local peering gateway (LPG) 1410 that can be communicatively coupled to a secure shell (SSH) VCN 1412 via an LPG 1410 contained in the SSH VCN 1412. The SSH VCN 1412 can include an SSH subnet 1414, and the SSH VCN 1412 can be communicatively coupled to a control plane VCN 1416 via the LPG 1410 contained in the control plane VCN 1416. Also, the SSH VCN 1412 can be communicatively coupled to a data plane VCN 1418 via an LPG 1410. The control plane VCN 1416 and the data plane VCN 1418 can be contained in a service tenancy 1419 that can be owned and/or operated by the IaaS provider.

The control plane VCN 1416 can include a control plane demilitarized zone (DMZ) tier 1420 that acts as a perimeter network (e.g., portions of a corporate network between the corporate intranet and external networks). The DMZ-based servers may have restricted responsibilities and help keep breaches contained. Additionally, the DMZ tier 1420 can include one or more load balancer (LB) subnet(s) 1422, a control plane app tier 1424 that can include app subnet(s) 1426, a control plane data tier 1428 that can include database (DB) subnet(s) 1430 (e.g., frontend DB subnet(s) and/or backend DB subnet(s)). The LB subnet(s) 1422 contained in the control plane DMZ tier 1420 can be communicatively coupled to the app subnet(s) 1426 contained in the control plane app tier 1424 and an Internet gateway 1434 that can be contained in the control plane VCN 1416, and the app subnet(s) 1426 can be communicatively coupled to the DB subnet(s) 1430 contained in the control plane data tier 1428 and a service gateway 1436 and a network address translation (NAT) gateway 1438. The control plane VCN 1416 can include the service gateway 1436 and the NAT gateway 1438.

The control plane VCN 1416 can include a data plane mirror app tier 1440 that can include app subnet(s) 1426. The app subnet(s) 1426 contained in the data plane mirror app tier 1440 can include a virtual network interface controller (VNIC) 1442 that can execute a compute instance 1444. The compute instance 1444 can communicatively couple the app subnet(s) 1426 of the data plane mirror app tier 1440 to app subnet(s) 1426 that can be contained in a data plane app tier 1446.

The data plane VCN 1418 can include the data plane app tier 1446, a data plane DMZ tier 1448, and a data plane data tier 1450. The data plane DMZ tier 1448 can include LB subnet(s) 1422 that can be communicatively coupled to the app subnet(s) 1426 of the data plane app tier 1446 and the Internet gateway 1434 of the data plane VCN 1418. The app subnet(s) 1426 can be communicatively coupled to the service gateway 1436 of the data plane VCN 1418 and the NAT gateway 1438 of the data plane VCN 1418. The data plane data tier 1450 can also include the DB subnet(s) 1430 that can be communicatively coupled to the app subnet(s) 1426 of the data plane app tier 1446.

The Internet gateway 1434 of the control plane VCN 1416 and of the data plane VCN 1418 can be communicatively coupled to a metadata management service 1452 that can be communicatively coupled to public Internet 1454. Public Internet 1454 can be communicatively coupled to the NAT gateway 1438 of the control plane VCN 1416 and of the data plane VCN 1418. The service gateway 1436 of the control plane VCN 1416 and of the data plane VCN 1418 can be communicatively coupled to cloud services 1456.

In some examples, the service gateway 1436 of the control plane VCN 1416 or of the data plane VCN 1418 can make application programming interface (API) calls to cloud services 1456 without going through public Internet 1454. The API calls to cloud services 1456 from the service gateway 1436 can be one-way: the service gateway 1436 can make API calls to cloud services 1456, and cloud services 1456 can send requested data to the service gateway 1436. But, cloud services 1456 may not initiate API calls to the service gateway 1436.

In some examples, the secure host tenancy 1404 can be directly connected to the service tenancy 1419, which may be otherwise isolated. The secure host subnet 1408 can communicate with the SSH subnet 1414 through an LPG 1410 that may enable two-way communication over an otherwise isolated system. Connecting the secure host subnet 1408 to the SSH subnet 1414 may give the secure host subnet 1408 access to other entities within the service tenancy 1419.

The control plane VCN 1416 may allow users of the service tenancy 1419 to set up or otherwise provision desired resources. Desired resources provisioned in the control plane VCN 1416 may be deployed or otherwise used in the data plane VCN 1418. In some examples, the control plane VCN 1416 can be isolated from the data plane VCN 1418, and the data plane mirror app tier 1440 of the control plane VCN 1416 can communicate with the data plane app tier 1446 of the data plane VCN 1418 via VNICs 1442 that can be contained in the data plane mirror app tier 1440 and the data plane app tier 1446.

In some examples, users of the system, or customers, can make requests, for example create, read, update, or delete (CRUD) operations, through public Internet 1454 that can communicate the requests to the metadata management service 1452. The metadata management service 1452 can communicate the request to the control plane VCN 1416 through the Internet gateway 1434. The request can be received by the LB subnet(s) 1422 contained in the control plane DMZ tier 1420. The LB subnet(s) 1422 may determine that the request is valid, and in response to this determination, the LB subnet(s) 1422 can transmit the request to app subnet(s) 1426 contained in the control plane app tier 1424. If the request is validated and requires a call to public Internet 1454, the call to public Internet 1454 may be transmitted to the NAT gateway 1438 that can make the call to public Internet 1454. Metadata that may be desired to be stored by the request can be stored in the DB subnet(s) 1430.

In some examples, the data plane mirror app tier 1440 can facilitate direct communication between the control plane VCN 1416 and the data plane VCN 1418. For example, changes, updates, or other suitable modifications to configuration may be desired to be applied to the resources contained in the data plane VCN 1418. Via a VNIC 1442, the control plane VCN 1416 can directly communicate with, and can thereby execute the changes, updates, or other suitable modifications to configuration to, resources contained in the data plane VCN 1418.

In some embodiments, the control plane VCN 1416 and the data plane VCN 1418 can be contained in the service tenancy 1419. In this case, the user, or the customer, of the system may not own or operate either the control plane VCN 1416 or the data plane VCN 1418. Instead, the IaaS provider may own or operate the control plane VCN 1416 and the data plane VCN 1418, both of which may be contained in the service tenancy 1419. This embodiment can enable isolation of networks that may prevent users or customers from interacting with other users', or other customers', resources. Also, this embodiment may allow users or customers of the system to store databases privately without needing to rely on public Internet 1454, which may not have a desired level of threat prevention, for storage.

In other embodiments, the LB subnet(s) 1422 contained in the control plane VCN 1416 can be configured to receive a signal from the service gateway 1436. In this embodiment, the control plane VCN 1416 and the data plane VCN 1418 may be configured to be called by a customer of the IaaS provider without calling public Internet 1454. Customers of the IaaS provider may desire this embodiment since database(s) that the customers use may be controlled by the IaaS provider and may be stored on the service tenancy 1419, which may be isolated from public Internet 1454.

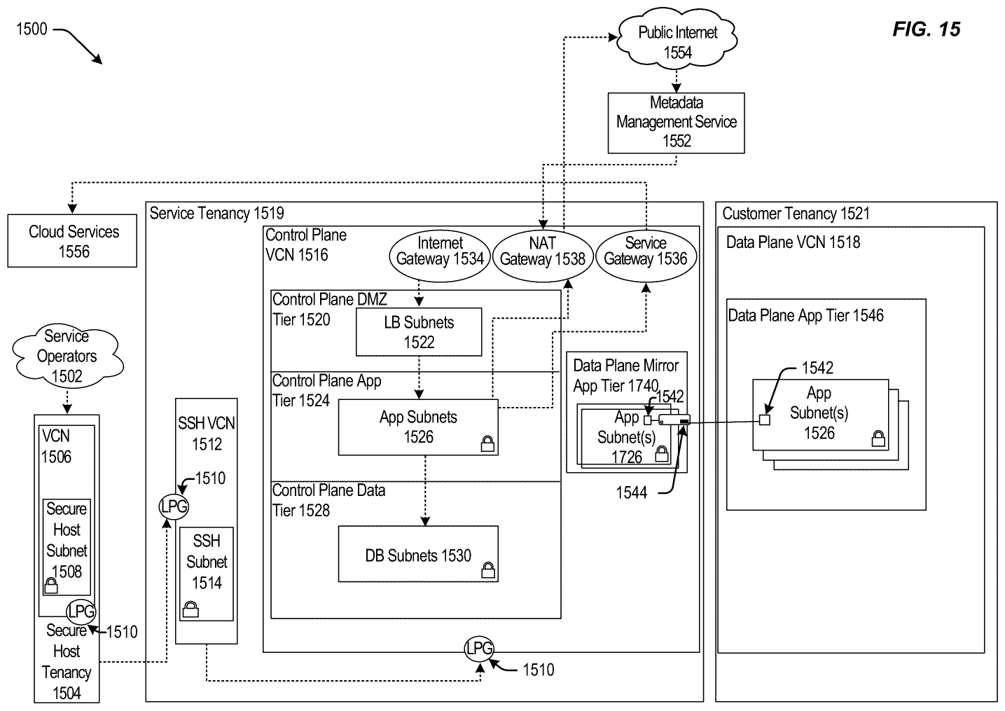

FIG. 15 is a block diagram 1500 illustrating another example pattern of an IaaS architecture, according to at least one embodiment. Service operators 1502 (e.g., service operators 1402 of FIG. 14) can be communicatively coupled to a secure host tenancy 1504 (e.g., the secure host tenancy 1404 of FIG. 14) that can include a virtual cloud network (VCN) 1506 (e.g., the VCN 1406 of FIG. 14) and a secure host subnet 1508 (e.g., the secure host subnet 1408 of FIG. 14). The VCN 1506 can include a local peering gateway (LPG) 1510 (e.g., the LPG 1410 of FIG. 14) that can be communicatively coupled to a secure shell (SSH) VCN 1512 (e.g., the SSH VCN 1412 of FIG. 14) via an LPG 1410 contained in the SSH VCN 1512. The SSH VCN 1512 can include an SSH subnet 1514 (e.g., the SSH subnet 1414 of FIG. 14), and the SSH VCN 1512 can be communicatively coupled to a control plane VCN 1516 (e.g., the control plane VCN 1416 of FIG. 14) via an LPG 1510 contained in the control plane VCN 1516. The control plane VCN 1516 can be contained in a service tenancy 1519 (e.g., the service tenancy 1419 of FIG. 14), and the data plane VCN 1518 (e.g., the data plane VCN 1418 of FIG. 14) can be contained in a customer tenancy 1521 that may be owned or operated by users, or customers, of the system.

The control plane VCN 1516 can include a control plane DMZ tier 1520 (e.g., the control plane DMZ tier 1420 of FIG. 14) that can include LB subnet(s) 1522 (e.g., LB subnet(s) 1422 of FIG. 14), a control plane app tier 1524 (e.g., the control plane app tier 1424 of FIG. 14) that can include app subnet(s) 1526 (e.g., app subnet(s) 1426 of FIG. 14), a control plane data tier 1528 (e.g., the control plane data tier 1428 of FIG. 14) that can include database (DB) subnet(s) 1530 (e.g., similar to DB subnet(s) 1430 of FIG. 14). The LB subnet(s) 1522 contained in the control plane DMZ tier 1520 can be communicatively coupled to the app subnet(s) 1526 contained in the control plane app tier 1524 and an Internet gateway 1534 (e.g., the Internet gateway 1434 of FIG. 14) that can be contained in the control plane VCN 1516, and the app subnet(s) 1526 can be communicatively coupled to the DB subnet(s) 1530 contained in the control plane data tier 1528 and a service gateway 1536 (e.g., the service gateway 1436 of FIG. 14) and a network address translation (NAT) gateway 1538 (e.g., the NAT gateway 1438 of FIG. 14). The control plane VCN 1516 can include the service gateway 1536 and the NAT gateway 1538.

The control plane VCN 1516 can include a data plane mirror app tier 1540 (e.g., the data plane mirror app tier 1440 of FIG. 14) that can include app subnet(s) 1526. The app subnet(s) 1526 contained in the data plane mirror app tier 1540 can include a virtual network interface controller (VNIC) 1542 (e.g., the VNIC of 1442) that can execute a compute instance 1544 (e.g., similar to the compute instance 1444 of FIG. 14). The compute instance 1544 can facilitate communication between the app subnet(s) 1526 of the data plane mirror app tier 1540 and the app subnet(s) 1526 that can be contained in a data plane app tier 1546 (e.g., the data plane app tier 1446 of FIG. 14) via the VNIC 1542 contained in the data plane mirror app tier 1540 and the VNIC 1542 contained in the data plane app tier 1546.

The Internet gateway 1534 contained in the control plane VCN 1516 can be communicatively coupled to a metadata management service 1552 (e.g., the metadata management service 1452 of FIG. 14) that can be communicatively coupled to public Internet 1554 (e.g., public Internet 1454 of FIG. 14). Public Internet 1554 can be communicatively coupled to the NAT gateway 1538 contained in the control plane VCN 1516. The service gateway 1536 contained in the control plane VCN 1516 can be communicatively coupled to cloud services 1556 (e.g., cloud services 1456 of FIG. 14).

In some examples, the data plane VCN 1518 can be contained in the customer tenancy 1521. In this case, the IaaS provider may provide the control plane VCN 1516 for each customer, and the IaaS provider may, for each customer, set up a unique compute instance 1544 that is contained in the service tenancy 1519. Each compute instance 1544 may allow communication between the control plane VCN 1516, contained in the service tenancy 1519, and the data plane VCN 1518 that is contained in the customer tenancy 1521. The compute instance 1544 may allow resources, that are provisioned in the control plane VCN 1516 that is contained in the service tenancy 1519, to be deployed or otherwise used in the data plane VCN 1518 that is contained in the customer tenancy 1521.

In other examples, the customer of the IaaS provider may have databases that live in the customer tenancy 1521. In this example, the control plane VCN 1516 can include the data plane mirror app tier 1540 that can include app subnet(s) 1526. The data plane mirror app tier 1540 can reside in the data plane VCN 1518, but the data plane mirror app tier 1540 may not live in the data plane VCN 1518. That is, the data plane mirror app tier 1540 may have access to the customer tenancy 1521, but the data plane mirror app tier 1540 may not exist in the data plane VCN 1518 or be owned or operated by the customer of the IaaS provider. The data plane mirror app tier 1540 may be configured to make calls to the data plane VCN 1518 but may not be configured to make calls to any entity contained in the control plane VCN 1516. The customer may desire to deploy or otherwise use resources in the data plane VCN 1518 that are provisioned in the control plane VCN 1516, and the data plane mirror app tier 1540 can facilitate the desired deployment, or other usage of resources, of the customer.

In some embodiments, the customer of the IaaS provider can apply filters to the data plane VCN 1518. In this embodiment, the customer can determine what the data plane VCN 1518 can access, and the customer may restrict access to public Internet 1554 from the data plane VCN 1518. The IaaS provider may not be able to apply filters or otherwise control access of the data plane VCN 1518 to any outside networks or databases. Applying filters and controls by the customer onto the data plane VCN 1518, contained in the customer tenancy 1521, can help isolate the data plane VCN 1518 from other customers and from public Internet 1554.

In some embodiments, cloud services 1556 can be called by the service gateway 1536 to access services that may not exist on public Internet 1554, on the control plane VCN 1516, or on the data plane VCN 1518. The connection between cloud services 1556 and the control plane VCN 1516 or the data plane VCN 1518 may not be live or continuous. Cloud services 1556 may exist on a different network owned or operated by the IaaS provider. Cloud services 1556 may be configured to receive calls from the service gateway 1536 and may be configured to not receive calls from public Internet 1554. Some cloud services 1556 may be isolated from other cloud services 1556, and the control plane VCN 1516 may be isolated from cloud services 1556 that may not be in the same region as the control plane VCN 1516. For example, the control plane VCN 1516 may be located in “Region 1,” and cloud service “Deployment 14,” may be located in Region 1 and in “Region 2.” If a call to Deployment 14 is made by the service gateway 1536 contained in the control plane VCN 1516 located in Region 1, the call may be transmitted to Deployment 14 in Region 1. In this example, the control plane VCN 1516, or Deployment 14 in Region 1, may not be communicatively coupled to, or otherwise in communication with, Deployment 14 in Region 2.

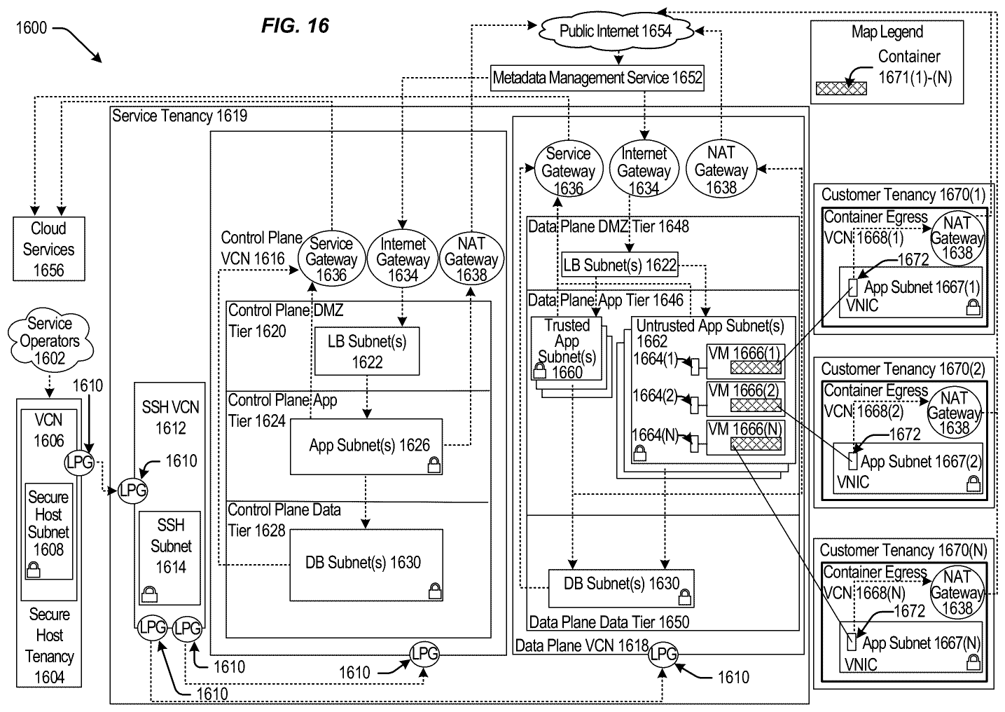

FIG. 16 is a block diagram 1600 illustrating another example pattern of an IaaS architecture, according to at least one embodiment. Service operators 1602 (e.g., service operators 1402 of FIG. 14) can be communicatively coupled to a secure host tenancy 1604 (e.g., the secure host tenancy 1404 of FIG. 14) that can include a virtual cloud network (VCN) 1606 (e.g., the VCN 1406 of FIG. 14) and a secure host subnet 1608 (e.g., the secure host subnet 1408 of FIG. 14). The VCN 1606 can include an LPG 1610 (e.g., the LPG 1410 of FIG. 14) that can be communicatively coupled to an SSH VCN 1612 (e.g., the SSH VCN 1412 of FIG. 14) via an LPG 1610 contained in the SSH VCN 1612. The SSH VCN 1612 can include an SSH subnet 1614 (e.g., the SSH subnet 1414 of FIG. 14), and the SSH VCN 1612 can be communicatively coupled to a control plane VCN 1616 (e.g., the control plane VCN 1416 of FIG. 14) via an LPG 1610 contained in the control plane VCN 1616 and to a data plane VCN 1618 (e.g., the data plane 1418 of FIG. 14) via an LPG 1610 contained in the data plane VCN 1618. The control plane VCN 1616 and the data plane VCN 1618 can be contained in a service tenancy 1619 (e.g., the service tenancy 1419 of FIG. 14).

The control plane VCN 1616 can include a control plane DMZ tier 1620 (e.g., the control plane DMZ tier 1420 of FIG. 14) that can include load balancer (LB) subnet(s) 1622 (e.g., LB subnet(s) 1422 of FIG. 14), a control plane app tier 1624 (e.g., the control plane app tier 1424 of FIG. 14) that can include app subnet(s) 1626 (e.g., similar to app subnet(s) 1426 of FIG. 14), a control plane data tier 1628 (e.g., the control plane data tier 1428 of FIG. 14) that can include DB subnet(s) 1630. The LB subnet(s) 1622 contained in the control plane DMZ tier 1620 can be communicatively coupled to the app subnet(s) 1626 contained in the control plane app tier 1624 and to an Internet gateway 1634 (e.g., the Internet gateway 1434 of FIG. 14) that can be contained in the control plane VCN 1616, and the app subnet(s) 1626 can be communicatively coupled to the DB subnet(s) 1630 contained in the control plane data tier 1628 and to a service gateway 1636 (e.g., the service gateway of FIG. 14) and a network address translation (NAT) gateway 1638 (e.g., the NAT gateway 1438 of FIG. 14). The control plane VCN 1616 can include the service gateway 1636 and the NAT gateway 1638.

The data plane VCN 1618 can include a data plane app tier 1646 (e.g., the data plane app tier 1446 of FIG. 14), a data plane DMZ tier 1648 (e.g., the data plane DMZ tier 1448 of FIG. 14), and a data plane data tier 1650 (e.g., the data plane data tier 1450 of FIG. 14). The data plane DMZ tier 1648 can include LB subnet(s) 1622 that can be communicatively coupled to trusted app subnet(s) 1660 and untrusted app subnet(s) 1662 of the data plane app tier 1646 and the Internet gateway 1634 contained in the data plane VCN 1618. The trusted app subnet(s) 1660 can be communicatively coupled to the service gateway 1636 contained in the data plane VCN 1618, the NAT gateway 1638 contained in the data plane VCN 1618, and DB subnet(s) 1630 contained in the data plane data tier 1650. The untrusted app subnet(s) 1662 can be communicatively coupled to the service gateway 1636 contained in the data plane VCN 1618 and DB subnet(s) 1630 contained in the data plane data tier 1650. The data plane data tier 1650 can include DB subnet(s) 1630 that can be communicatively coupled to the service gateway 1636 contained in the data plane VCN 1618.

The untrusted app subnet(s) 1662 can include one or more primary VNICs 1664(1)-(N) that can be communicatively coupled to tenant virtual machines (VMs) 1666(1)-(N). Each tenant VM 1666(1)-(N) can be communicatively coupled to a respective app subnet 1667(1)-(N) that can be contained in respective container egress VCNs 1668(1)-(N) that can be contained in respective customer tenancies 1670(1)-(N). Respective secondary VNICs 1672(1)-(N) can facilitate communication between the untrusted app subnet(s) 1662 contained in the data plane VCN 1618 and the app subnet contained in the container egress VCNs 1668(1)-(N). Each container egress VCNs 1668(1)-(N) can include a NAT gateway 1638 that can be communicatively coupled to public Internet 1654 (e.g., public Internet 1454 of FIG. 14).

The Internet gateway 1634 contained in the control plane VCN 1616 and contained in the data plane VCN 1618 can be communicatively coupled to a metadata management service 1652 (e.g., the metadata management system 1452 of FIG. 14) that can be communicatively coupled to public Internet 1654. Public Internet 1654 can be communicatively coupled to the NAT gateway 1638 contained in the control plane VCN 1616 and contained in the data plane VCN 1618. The service gateway 1636 contained in the control plane VCN 1616 and contained in the data plane VCN 1618 can be communicatively coupled to cloud services 1656.

In some embodiments, the data plane VCN 1618 can be integrated with customer tenancies 1670. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1646. Code to run the function may be executed in the VMs 1666(1)-(N), and the code may not be configured to run anywhere else on the data plane VCN 1618. Each VM 1666(1)-(N) may be connected to one customer tenancy 1670. Respective containers 1671(1)-(N) contained in the VMs 1666(1)-(N) may be configured to run the code. In this case, there can be a dual isolation (e.g., the containers 1671(1)-(N) running code, where the containers 1671(1)-(N) may be contained in at least the VM 1666(1)-(N) that are contained in the untrusted app subnet(s) 1662), which may help prevent incorrect or otherwise undesirable code from damaging the network of the IaaS provider or from damaging a network of a different customer. The containers 1671(1)-(N) may be communicatively coupled to the customer tenancy 1670 and may be configured to transmit or receive data from the customer tenancy 1670. The containers 1671(1)-(N) may not be configured to transmit or receive data from any other entity in the data plane VCN 1618. Upon completion of running the code, the IaaS provider may kill or otherwise dispose of the containers 1671(1)-(N).

In some embodiments, the trusted app subnet(s) 1660 may run code that may be owned or operated by the IaaS provider. In this embodiment, the trusted app subnet(s) 1660 may be communicatively coupled to the DB subnet(s) 1630 and be configured to execute CRUD operations in the DB subnet(s) 1630. The untrusted app subnet(s) 1662 may be communicatively coupled to the DB subnet(s) 1630, but in this embodiment, the untrusted app subnet(s) may be configured to execute read operations in the DB subnet(s) 1630. The containers 1671(1)-(N) that can be contained in the VM 1666(1)-(N) of each customer and that may run code from the customer may not be communicatively coupled with the DB subnet(s) 1630.

In other embodiments, the control plane VCN 1616 and the data plane VCN 1618 may not be directly communicatively coupled. In this embodiment, there may be no direct communication between the control plane VCN 1616 and the data plane VCN 1618. However, communication can occur indirectly through at least one method. An LPG 1610 may be established by the IaaS provider that can facilitate communication between the control plane VCN 1616 and the data plane VCN 1618. In another example, the control plane VCN 1616 or the data plane VCN 1618 can make a call to cloud services 1656 via the service gateway 1636. For example, a call to cloud services 1656 from the control plane VCN 1616 can include a request for a service that can communicate with the data plane VCN 1618.

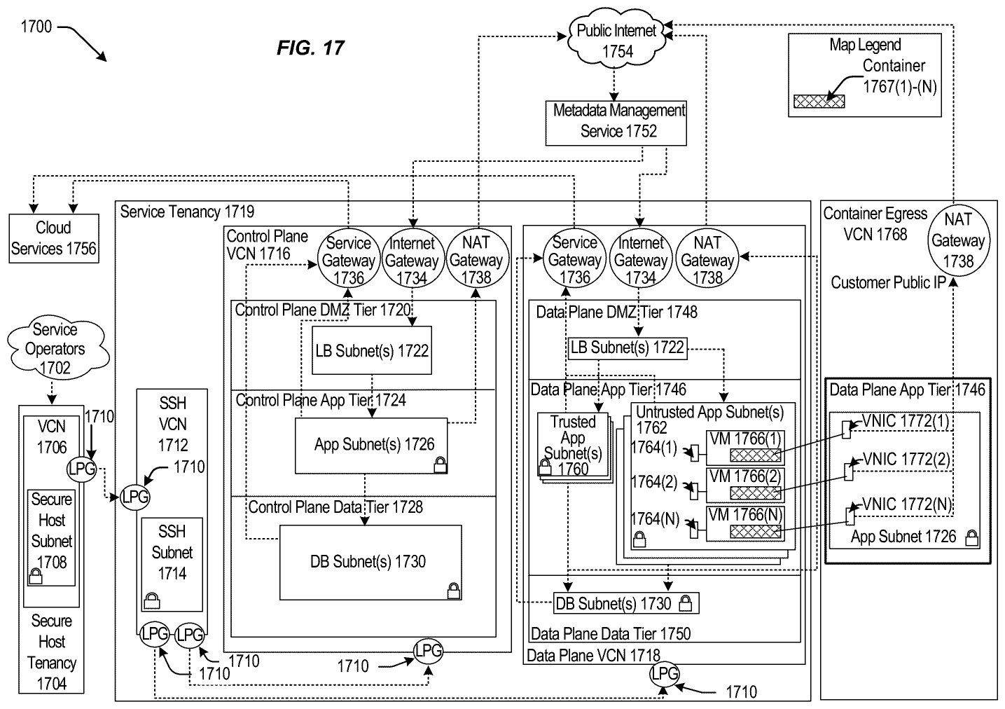

FIG. 17 is a block diagram 1700 illustrating another example pattern of an IaaS architecture, according to at least one embodiment. Service operators 1702 (e.g., service operators 1402 of FIG. 14) can be communicatively coupled to a secure host tenancy 1704 (e.g., the secure host tenancy 1404 of FIG. 14) that can include a virtual cloud network (VCN) 1706 (e.g., the VCN 1406 of FIG. 14) and a secure host subnet 1708 (e.g., the secure host subnet 1408 of FIG. 14). The VCN 1706 can include an LPG 1710 (e.g., the LPG 1410 of FIG. 14) that can be communicatively coupled to an SSH VCN 1712 (e.g., the SSH VCN 1412 of FIG. 14) via an LPG 1710 contained in the SSH VCN 1712. The SSH VCN 1712 can include an SSH subnet 1714 (e.g., the SSH subnet 1414 of FIG. 14), and the SSH VCN 1712 can be communicatively coupled to a control plane VCN 1716 (e.g., the control plane VCN 1416 of FIG. 14) via an LPG 1710 contained in the control plane VCN 1716 and to a data plane VCN 1718 (e.g., the data plane 1418 of FIG. 14) via an LPG 1710 contained in the data plane VCN 1718. The control plane VCN 1716 and the data plane VCN 1718 can be contained in a service tenancy 1719 (e.g., the service tenancy 1419 of FIG. 14).

The control plane VCN 1716 can include a control plane DMZ tier 1720 (e.g., the control plane DMZ tier 1420 of FIG. 14) that can include LB subnet(s) 1722 (e.g., LB subnet(s) 1422 of FIG. 14), a control plane app tier 1724 (e.g., the control plane app tier 1424 of FIG. 14) that can include app subnet(s) 1726 (e.g., app subnet(s) 1426 of FIG. 14), a control plane data tier 1728 (e.g., the control plane data tier 1428 of FIG. 14) that can include DB subnet(s) 1730 (e.g., DB subnet(s) 1630 of FIG. 16). The LB subnet(s) 1722 contained in the control plane DMZ tier 1720 can be communicatively coupled to the app subnet(s) 1726 contained in the control plane app tier 1724 and to an Internet gateway 1734 (e.g., the Internet gateway 1434 of FIG. 14) that can be contained in the control plane VCN 1716, and the app subnet(s) 1726 can be communicatively coupled to the DB subnet(s) 1730 contained in the control plane data tier 1728 and to a service gateway 1736 (e.g., the service gateway of FIG. 14) and a network address translation (NAT) gateway 1738 (e.g., the NAT gateway 1438 of FIG. 14). The control plane VCN 1716 can include the service gateway 1736 and the NAT gateway 1738.

The data plane VCN 1718 can include a data plane app tier 1746 (e.g., the data plane app tier 1446 of FIG. 14), a data plane DMZ tier 1748 (e.g., the data plane DMZ tier 1448 of FIG. 14), and a data plane data tier 1750 (e.g., the data plane data tier 1450 of FIG. 14). The data plane DMZ tier 1748 can include LB subnet(s) 1722 that can be communicatively coupled to trusted app subnet(s) 1760 (e.g., trusted app subnet(s) 1660 of FIG. 16) and untrusted app subnet(s) 1762 (e.g., untrusted app subnet(s) 1662 of FIG. 16) of the data plane app tier 1746 and the Internet gateway 1734 contained in the data plane VCN 1718. The trusted app subnet(s) 1760 can be communicatively coupled to the service gateway 1736 contained in the data plane VCN 1718, the NAT gateway 1738 contained in the data plane VCN 1718, and DB subnet(s) 1730 contained in the data plane data tier 1750. The untrusted app subnet(s) 1762 can be communicatively coupled to the service gateway 1736 contained in the data plane VCN 1718 and DB subnet(s) 1730 contained in the data plane data tier 1750. The data plane data tier 1750 can include DB subnet(s) 1730 that can be communicatively coupled to the service gateway 1736 contained in the data plane VCN 1718.

The untrusted app subnet(s) 1762 can include primary VNICs 1764(1)-(N) that can be communicatively coupled to tenant virtual machines (VMs) 1766(1)-(N) residing within the untrusted app subnet(s) 1762. Each tenant VM 1766(1)-(N) can run code in a respective container 1767(1)-(N), and be communicatively coupled to an app subnet 1726 that can be contained in a data plane app tier 1746 that can be contained in a container egress VCN 1768. Respective secondary VNICs 1772(1)-(N) can facilitate communication between the untrusted app subnet(s) 1762 contained in the data plane VCN 1718 and the app subnet contained in the container egress VCN 1768. The container egress VCN can include a NAT gateway 1738 that can be communicatively coupled to public Internet 1754 (e.g., public Internet 1454 of FIG. 14).

The Internet gateway 1734 contained in the control plane VCN 1716 and contained in the data plane VCN 1718 can be communicatively coupled to a metadata management service 1752 (e.g., the metadata management system 1452 of FIG. 14) that can be communicatively coupled to public Internet 1754. Public Internet 1754 can be communicatively coupled to the NAT gateway 1738 contained in the control plane VCN 1716 and contained in the data plane VCN 1718. The service gateway 1736 contained in the control plane VCN 1716 and contained in the data plane VCN 1718 can be communicatively coupled to cloud services 1756.

In some examples, the pattern illustrated by the architecture of block diagram 1700 of FIG. 17 may be considered an exception to the pattern illustrated by the architecture of block diagram 1600 of FIG. 16 and may be desirable for a customer of the IaaS provider if the IaaS provider cannot directly communicate with the customer (e.g., a disconnected region). The respective containers 1767(1)-(N) that are contained in the VMs 1766(1)-(N) for each customer can be accessed in real-time by the customer. The containers 1767(1)-(N) may be configured to make calls to respective secondary VNICs 1772(1)-(N) contained in app subnet(s) 1726 of the data plane app tier 1746 that can be contained in the container egress VCN 1768. The secondary VNICs 1772(1)-(N) can transmit the calls to the NAT gateway 1738 that may transmit the calls to public Internet 1754. In this example, the containers 1767(1)-(N) that can be accessed in real-time by the customer can be isolated from the control plane VCN 1716 and can be isolated from other entities contained in the data plane VCN 1718. The containers 1767(1)-(N) may also be isolated from resources from other customers.

In other examples, the customer can use the containers 1767(1)-(N) to call cloud services 1756. In this example, the customer may run code in the containers 1767(1)-(N) that requests a service from cloud services 1756. The containers 1767(1)-(N) can transmit this request to the secondary VNICs 1772(1)-(N) that can transmit the request to the NAT gateway that can transmit the request to public Internet 1754. Public Internet 1754 can transmit the request to LB subnet(s) 1722 contained in the control plane VCN 1716 via the Internet gateway 1734. In response to determining the request is valid, the LB subnet(s) can transmit the request to app subnet(s) 1726 that can transmit the request to cloud services 1756 via the service gateway 1736.

It should be appreciated that IaaS architectures 1400, 1500, 1600, 1700 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

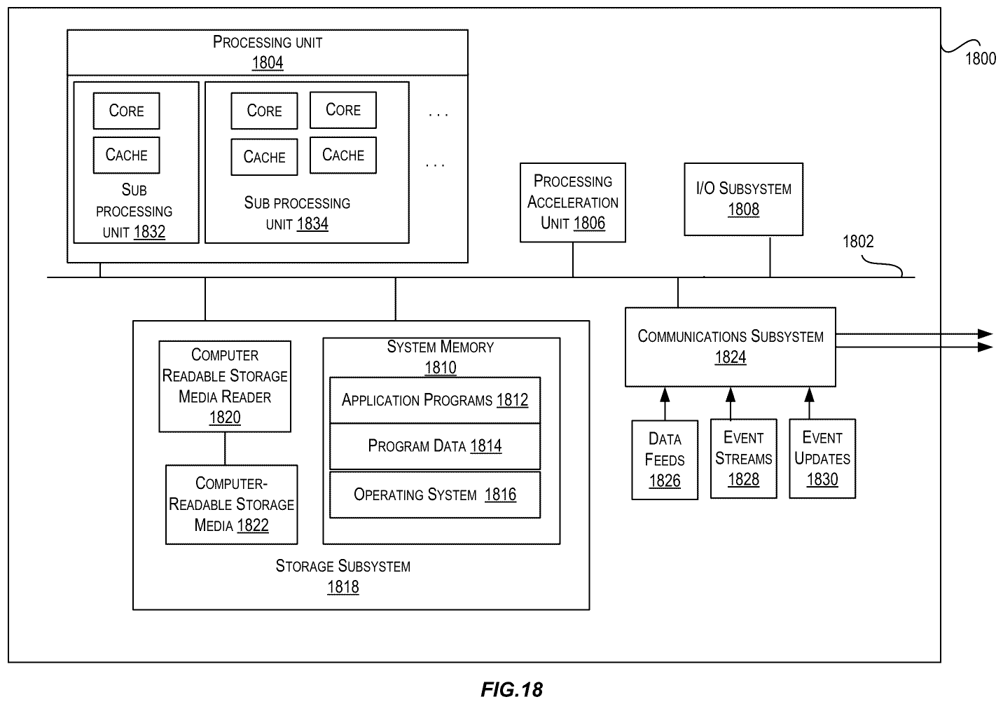

FIG. 18 illustrates an example computer system 1800, in which various embodiments may be implemented. The system 1800 may be used to implement any of the computer systems described above. As shown in the figure, computer system 1800 includes a processing unit 1804 that communicates with a number of peripheral subsystems via a bus subsystem 1802. These peripheral subsystems may include a processing acceleration unit 1806, an I/O subsystem 1808, a storage subsystem 1818 and a communications subsystem 1824. Storage subsystem 1818 includes tangible computer-readable storage media 1822 and a system memory 1810.

Bus subsystem 1802 provides a mechanism for letting the various components and subsystems of computer system 1800 communicate with each other as intended. Although bus subsystem 1802 is shown schematically as a single bus, alternative embodiments of the bus subsystem may utilize multiple buses. Bus subsystem 1802 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1804, which can be implemented as one or more integrated circuits (e.g., a conventional microprocessor or microcontroller), controls the operation of computer system 1800. One or more processors may be included in processing unit 1804. These processors may include single core or multicore processors. In certain embodiments, processing unit 1804 may be implemented as one or more independent processing units 1832 and/or 1834 with single or multicore processors included in each processing unit. In other embodiments, processing unit 1804 may also be implemented as a quad-core processing unit formed by integrating two dual-core processors into a single chip.

In various embodiments, processing unit 1804 can execute a variety of programs in response to program code and can maintain multiple concurrently executing programs or processes. At any given time, some or all of the program code to be executed can be resident in processor(s) 1804 and/or in storage subsystem 1818. Through suitable programming, processor(s) 1804 can provide various functionalities described above. Computer system 1800 may additionally include a processing acceleration unit 1806, which can include a digital signal processor (DSP), a special-purpose processor, and/or the like.

I/O subsystem 1808 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1800 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1800 may comprise a storage subsystem 1818 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1804 provide the functionality described above. Storage subsystem 1818 may also provide a repository for storing data used in accordance with the present disclosure.

As depicted in the example in FIG. 18, storage subsystem 1818 can include various components including a system memory 1810, computer-readable storage media 1822, and a computer readable storage media reader 1820. System memory 1810 may store program instructions that are loadable and executable by processing unit 1804. System memory 1810 may also store data that is used during the execution of the instructions and/or data that is generated during the execution of the program instructions. Various different kinds of programs may be loaded into system memory 1810 including but not limited to client applications, Web browsers, mid-tier applications, relational database management systems (RDBMS), virtual machines, containers, etc.

System memory 1810 may also store an operating system 1816. Examples of operating system 1816 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1800 executes one or more virtual machines, the virtual machines along with their guest operating systems (GOSs) may be loaded into system memory 1810 and executed by one or more processors or cores of processing unit 1804.

System memory 1810 can come in different configurations depending upon the type of computer system 1800. For example, system memory 1810 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1810 may include a basic input/output system (BIOS) containing basic routines that help to transfer information between elements within computer system 1800, such as during start-up.

Computer-readable storage media 1822 may represent remote, local, fixed, and/or removable storage devices plus storage media for temporarily and/or more permanently containing, storing, computer-readable information for use by computer system 1800 including instructions executable by processing unit 1804 of computer system 1800.

Computer-readable storage media 1822 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1822 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1822 may include, but is not limited to, Zip® drives, flash memory cards, universal serial bus (USB) flash drives, secure digital (SD) cards, DVD disks, digital video tape, and the like. Computer-readable storage media 1822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1800.

Machine-readable instructions executable by one or more processors or cores of processing unit 1804 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1824 provides an interface to other computer systems and networks. Communications subsystem 1824 serves as an interface for receiving data from and transmitting data to other systems from computer system 1800. For example, communications subsystem 1824 may enable computer system 1800 to connect to one or more devices via the Internet. In some embodiments communications subsystem 1824 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1824 can provide wired network connectivity (e.g., Ethernet) in addition to or instead of a wireless interface.

In some embodiments, communications subsystem 1824 may also receive input communication in the form of structured and/or unstructured data feeds 1826, event streams 1828, event updates 1830, and the like on behalf of one or more users who may use computer system 1800.

By way of example, communications subsystem 1824 may be configured to receive data feeds 1826 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1824 may also be configured to receive data in the form of continuous data streams, which may include event streams 1828 of real-time events and/or event updates 1830, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1824 may also be configured to output the structured and/or unstructured data feeds 1826, event streams 1828, event updates 1830, and the like to one or more databases that may be in communication with one or more streaming data source computers coupled to computer system 1800.

Computer system 1800 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1800 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
identifying, by a computing system, a custom class;
selecting, by a computing system, a pretrained base model trained to predict a base class, the selection based at least in part on the base class belonging to a same domain as the custom class;
generating, by the computing system, an untrained inter type extender model to be trained to predict the custom class from data points associated with the custom class, the untrained inter type extender model comprising an untrained fusion layer and an untrained inter type extender;
connecting, by the computing system, the pretrained base model in parallel to the untrained inter type extender model to generate an inter type augmented model;
inputting, by the computing system, a training image into the inter type augmented model, the training image comprising the data points associated with the custom class;
causing, by computing system and based at least in part on the training image, a first block of the pretrained base model to output a first plurality of activations associated with the base class;
causing, by the computing system, the untrained fusion layer to generate a plurality of weights for weighting the first plurality of activations, the plurality of weights configured to cause the untrained inter type extender model to identify the custom class from the training image;
causing, by the computing system, the untrained fusion layer to generate a weighted sum based at least in part on weighting the first plurality of activations using the plurality of weights;
causing, by the computing system, the untrained inter type extender to generate a second plurality of activations based at least in part on the weighted sum;
causing, by the computing system, the untrained inter type extender model to predict the custom class from the training image based at least in part on the second plurality of activations; and
causing, by the computing system, the pretrained base model to predict the base class from the training image based at least in part on the first plurality of activations.

2. The method of claim 1, wherein the method further comprises:
generating a plurality of vectors based at least in part on the training image;
generating a plurality of activation scores based at least in part on the vectors; and
generating a probability distribution based at least in part on the plurality of activation scores, wherein the probability distribution comprises the plurality of weights.

3. The method of claim 1, wherein the inter type augmented model is trained using a locked configuration, and wherein the method further comprises:
determining an accuracy of the untrained inter type extender model based at least in part on a loss function; and
adjusting a plurality of untrained inter type extender model weights based at least in part on the accuracy, wherein a plurality of pretrained base model weights remain unadjusted.

4. The method of claim 1, wherein the inter type augmented model is trained using an unlocked configuration, and wherein the method further comprises:
determining an accuracy of the untrained inter type extender model based at least in part on a loss function;
adjusting a plurality of pretrained base model weights based at least in a part on the accuracy; and
adjusting a plurality of untrained inter type extender model weights based at least in a part on the accuracy.

5. The method of claim 1, wherein the method further comprises:
accessing a data store that stores the pretrained base model;
identifying a pretrained inter type extender model based at least in part on metadata stored in the data store and associated with the pretrained inter type extender model, wherein the pretrained inter type extender model is trained to identify a class belonging to the same domain as the custom class; and
connecting the pretrained inter type extender model to the pretrained base model and untrained inter type extender model.

6. The method claim 5, wherein the method further comprises:
transmitting, in response to the untrained inter type extender model identifying the custom class from the training image, first control instructions to a data store to store the untrained inter type extender model; and
transmitting second control instructions to the data store to update metadata associated with the pretrained base model to indicate generation of the inter type augmented model.

7. The method of claim 1, wherein the method further comprises:
determining whether to generate the inter type augmented model based at least in part on the custom class.

8. A computing system comprising:
one or more processors; and
one or non-transitory computer-readable media comprising a sequence of instructions which, when executed on the one or more processors, cause the one or more processors to:
identify an identity of a custom class;
select a pretrained base model trained to predict a base class, the selection based at least in part on the base class belonging to a same domain as the custom class;
generate an untrained intra type extender model to be trained to identify the custom class from data points associated with the custom class, the untrained intra type extender model comprising an untrained fusion layer, a first untrained intra type extender layer and a second untrained extender layer;
connect the untrained intra type extender model to the pretrained base model to generate an intra type augmented model;
input a training image to the intra type augmented model, the training image comprising the data points associated with the custom class;
cause, based at least in part on the training image, a first block of the pretrained base model to output a first plurality of activations;
cause, based at least in part on the training image, the first untrained intra type extender layer to output a second plurality of activations;
cause the untrained fusion layer to generate a plurality of weights for weighting the first plurality of activations and the second plurality of activations, the plurality of weights configured to cause the intra type augmented model to identify the custom class from the training image;
cause the untrained fusion layer to generate a weighted sum based at least in part on weighting the first plurality of activations and the second plurality of activations using the plurality of weights;
cause a second block of the pretrained base model to output a third plurality of activations based at least in part on the weighted sum;
cause the second untrained extender layer to output a fourth plurality of activations based at least in part on the weighted sum;
cause the intra type augmented model to predict the custom class from the training image based at least in part on the third plurality of activations and the fourth plurality of activations.

9. The computing system of claim 8, wherein sequence of instructions which, when executed on the one or more processors, further cause the one or more processors to:
generate a plurality of vectors based at least in part on the training image;
generate a plurality of activation scores based at least in part on the vectors; and
generate a probability distribution based at least in part on the plurality of activation scores, wherein the probability distribution comprises the plurality of weights.

10. The computing system of claim 9, wherein the intra type augmented model is trained using a locked configuration, and wherein sequence of instructions which, when executed on the one or more processors, further cause the one or more processors to:
determine an accuracy of the untrained intra type extender model based at least in part on a loss function; and
adjust a plurality of untrained intra type extender model weights based at least in part on the accuracy, wherein a plurality of pretrained base model weights remain unadjusted.

11. The computing system of claim 9, wherein the intra type augmented model is trained using an unlocked configuration, and wherein sequence of instructions which, when executed on the one or more processors, further cause the one or more processors to:
determine an accuracy of the untrained intra type extender model based at least in part on a loss function;
adjust a plurality of pretrained base model weights based at least in a part on the accuracy; and
adjust a plurality of untrained intra type extender model weights based at least in a part on the accuracy.

12. The computing system of claim 8, wherein the sequence of instructions which, when executed on the one or more processors, further cause the one or more processors to:
access a data store that stores the pretrained base model;
identify a pretrained intra type extender model based at least in part on metadata stored in the data store and associated with the pretrained intra type extender model, wherein the pretrained intra type extender model is trained to identify a class belonging to the same domain as the custom class; and
connect the pretrained intra type extender model to the pretrained base model and untrained intra type extender model.

13. The computing system claim 12, wherein the sequence of instructions which, when executed on the one or more processors, further cause the one or more processors to:
transmit, in response to the untrained intra type extender model identifying the custom class from the training image, first control instructions to a data store to store the untrained intra type extender model; and
transmit second control instructions to the data store to update metadata associated with the pretrained base model to indicate generation of the intra type augmented model.

14. The computing system of claim 8, wherein the sequence of instructions which, when executed on the one or more processors, further cause the one or more processors to:
determine whether to generate the intra type augmented model based at least in part on the custom class.

15. One or more non-transitory computer-readable media comprising a sequence of instructions that, when executed by one or more processors, cause a computing system to:
identify a custom class;
select a pretrained base model trained to predict a base class, the selection based at least in part on the base class belonging to a same domain as the custom class;
generate an untrained inter type extender model to be trained to predict the custom class from data points associated with the custom class, the untrained inter type extender model comprising an untrained fusion layer and an untrained inter type extender;
connect the pretrained base model in parallel to the untrained inter type extender model to generate an inter type augmented model;
input a training image into the inter type augmented model, the training image comprising the data points associated with the custom class;
cause, based at least in part on the training image, a first block of the pretrained base model to output a first plurality of activations associated with the base class;
cause the untrained fusion layer to generate a plurality of weights for weighting the first plurality of activations, the plurality of weights configured to cause the untrained inter type extender model to identify the custom class from the training image;
cause the untrained fusion layer to generate a weighted sum based at least in part on weighting the first plurality of activations using the plurality of weights;
cause the untrained inter type extender to generate a second plurality of activations based at least in part on the weighted sum;
cause the untrained inter type extender model to predict the custom class from the training image based at least in part on the second plurality of activations; and
cause the pretrained base model to predict the base class from the training image based at least in part on the first plurality of activations.

16. The one or more non-transitory computer-readable media of claim 15,
wherein the sequence of instructions which, when executed on the one or more processors, further cause the one or more processors to:
generate a plurality of vectors based at least in part on the training image;
generate a plurality of activation scores based at least in part on the vectors; and
generate a probability distribution based at least in part on the plurality of activation scores, wherein the probability distribution comprises the plurality of weights.

17. The one or more non-transitory computer-readable media of claim 16, wherein the inter type augmented model is trained using a locked configuration, and wherein the sequence of instructions which, when executed on the one or more processors, further cause the one or more processors to:
determine an accuracy of the untrained inter type extender model based at least in part on a loss function; and
adjust a plurality of weights of the untrained inter type extender model based at least in part on the accuracy, wherein weights of the pretrained base model remain unadjusted.

18. The one or more non-transitory computer-readable media of claim 15, wherein the inter type augmented model is trained using an unlocked configuration, and wherein the sequence of instructions which, when executed on the one or more processors, further cause the one or more processors to:
determine an accuracy of the untrained inter type extender model based at least in part on a loss function;
adjust a plurality of pretrained base model weights based at least in a part on the accuracy; and
adjust a plurality of untrained inter type extender model weights based at least in a part on the accuracy.

19. The one or more non-transitory computer-readable media of claim 15, wherein the sequence of instructions which, when executed on the one or more processors, further cause the one or more processors to:
access a data store that stores the pretrained base model;
identify a pretrained inter type extender model based at least in part on metadata stored in the data store and associated with the pretrained inter type extender model, wherein the pretrained inter type extender model is trained to identify a class belonging to the same domain as the custom class; and
connect the pretrained inter type extender model to the pretrained base model and untrained inter type extender model.

20. The one or more non-transitory computer-readable media of claim 15, wherein the sequence of instructions which, when executed on the one or more processors, further cause the one or more processors to:
transmit, in response to the untrained inter type extender model identifying the custom class from the training image, first control instructions to a data store to store the untrained inter type extender model; and
transmit second control instructions to the data store to update metadata associated with the pretrained base model to indicate generation of the inter type augmented model.

21. A method, comprising:
receiving, by a data store, a message requesting a model trained to predict a custom class;
selecting, by the data store, a pretrained base model from a plurality of pretrained base models that is trained to predict a base class belonging to a same domain as the custom class;
selecting, by the data store, a first pretrained extender model from a plurality of pretrained extender models, the first pretrained extender model associated with the pretrained base model based at least in part on selecting the pretrained base model, the first pretrained extender model trained to predict the custom class;
connecting, by the data store, the pretrained base model to the first pretrained extender model to generate an augmented model based at least in part on the first pretrained extender model being trained to predict the custom class, the pretrained base model connected to the first pretrained extender model such that a first output of a first block of the pretrained base model is received by a first pretrained fusion layer of the pretrained extender model; and
transmitting, by the data store, the augmented model to a sender of the message.

22. The method of claim 21, wherein the method further comprises:
receiving a message indicating that the pretrained base model was used to train a second pretrained extender model, the second pretrained extender model trained to predict a class belonging to the same domain as the base class and the custom class;
generating metadata to associate the pretrained base model with the second pretrained extender model;
identifying the second pretrained extender model based at least in part on the metadata; and
connecting the second pretrained extender model to the pretrained base model, wherein the augmented model comprises the pretrained base model, the first pretrained extender model, and the second pretrained extender model.

23. The method of claim 21, wherein selecting the pretrained base model from a plurality of pretrained base models that is trained to predict a base class belonging to a same domain as the custom class comprises:
accessing first metadata stored in the data store and associated with the pretrained base model, wherein the first metadata comprises an identity of the base class; and
determining, using a mapping, an association between the base class and the custom class based at least in part on the first metadata and the message, wherein the pretrained base model is selected based at least in part on the association.

24. The method of claim 21, wherein selecting the first pretrained extender model from the plurality of pretrained extender models comprises:
accessing first metadata stored in the data store and associated with the pretrained base model, wherein the first metadata comprises an identity of the base class;
accessing second metadata stored in the data store and associated with the first pretrained extender model, wherein the second metadata comprises an identity of the custom class; and
determining, using a mapping, an association between the base class and the custom class based at least in part on the first metadata and the second metadata, wherein the first pretrained extender model is selected based at least in part on the association.

25. The method of claim 21, wherein the augmented model is an inter type augmented model, and wherein connecting the pretrained base model to the first pretrained extender model to generate the augmented model comprises:
connecting the first pretrained fusion layer to an input interface of the augmented model for receiving a training instance, such that the first pretrained fusion layer is configured to receive the output of the first block and the training instance;
connecting the first pretrained fusion layer to a first pretrained inter type extender of the first pretrained extender model; and
connecting, the first pretrained inter type extender to a second pretrained fusion layer of the of the first pretrained extender model.

26. The method of claim 21, wherein the augmented model is an intra type augmented model, and wherein connecting the pretrained base model to the first pretrained extender model to generate an augmented model comprises:
connecting a first pretrained intra type extender layer to the first pretrained fusion layer, such that a second output of the first pretrained intra type extender layer; and
connecting, the first pretrained fusion layer to a second block of the pretrained base model and a second pretrained intra type extender layer, such that a third output of the first pretrained fusion layer is received by the second block and the second pretrained intra type extender layer.

27. The method of claim 21, wherein the method further comprises:
generating metadata indicating the generation of the augmented model; and
storing the metadata in the data store.
